(19) United States
(12) Patent Application Publication
(10) Pub. No.: US 2023/0123006 A1
(43) Pub. Date: Apr. 20, 2023

(54) SYSTEMS, METHODS, MEDIA, AND PLATFORMS FOR SOURCING AND RECRUITING CANDIDATES INTO AN INTERVIEW PROCESS

(71) Applicant: RoleBot, Inc., Los Angeles, CA (US)

(72) Inventor: Shane Jeffrey BERNSTEIN, Los Angeles, CA (US)

(73) Assignee: RoleBot, Inc., Los Angeles, CA (US)

(21) Appl. No.: 17/966,351

(22) Filed: Oct. 14, 2022

Related U.S. Application Data
(60) Provisional application No. 63/256,072, filed on Oct. 15, 2021.

(51) Int. Cl. G06Q 10/10; G06F 16/9035

(52) U.S. Cl. CPC G06Q 10/1053; G06F 16/9035

(57) ABSTRACT

Various systems, methods, and media for sourcing and recruiting candidates into an interview process are provided. Identifying information that corresponds to at least one individual is received via an interface. At least one search parameter that relates to characteristic of the individual is determined. A look-a-like profile is created using the search parameter. Data from a search area of a network is searched based on the look-a-like profile to identify at least one look-a-like candidate, with the look-a-like candidate being different than the individual and having the characteristic in common with the individual. The look-a-like profile is modified based on the first look-a-like candidate, and the data from the search area of the network is again searched based on the modified look-a-like profile to identify at least one second look-a-like candidate.

### CROSS-REFERENCE TO RELATED APPLICATIONS

This application claims the benefit of U.S. Provisional Application No. 63/256,072, filed Oct. 15, 2021, the contents of which are incorporated by reference herein in entirety.

### BACKGROUND

### 1. Field of the Disclosure

The present disclosure generally relates to the field of employee recruitment and hiring. More particularly, the present disclosure relates to various systems, methods, media, and platforms for sourcing and recruiting candidates into an interview process.

### 2. Background Information

In the current job market, one typically finds a job by applying to a job posting, getting a job through a friend or peer, being recruited by an onsite corporate recruiter, being recruited by a third party recruitment agency, updating profiles on social media channels and networks, networking, or meeting someone by chance at a restaurant and being offered a job. Companies typically find talent by posting a job description on a job board, asking current employees for referrals, hiring corporate onsite recruiters to spread word, hiring third party staffing agencies to recruit, searching far and wide for a technology, or crossing their fingers and hoping to land employees based on reputation. FIG. 24 shows traditional means for sourcing talent including conducting key word searches, giving assessment tests, receiving internal referrals, utilizing in-house recruiters, job postings, and using third party recruitment agencies. The traditional means provide unverifiable, unreliable, inaccurate, and inconsistent results.

The traditional means do not provide any barrier to application, and the contents of an application, such as a resume, are unverified. In this regard, in-house recruiters lack the bandwidth and domain expertise to sort and verify applications. Approximately 65% of costs and time occur during the “sourcing” phase of the traditional means. Also, the “sourcing” phase, as well as subsequent phases, may require days, weeks, or even longer periods of time. As a result, companies are frequently looking for alternative means for finding talent.

According to an article published on USNews.com in 2015, 14% of new hires are employee referrals for companies with ninety-nine employees or less, 24% of new hires are employee referrals for companies with one hundred to nine hundred ninety-nine employees, and 27% of new hires are employee referrals for companies with at least one thousand employees. According to an article published on SHRM.org in 2016, about four in ten (39%) of nearly four thousand corporate talent acquisition managers from forty countries agreed that quality of hire is the most valuable metric for performance. In this regard, improved methods for locating quality talent are desired besides employee referrals, especially since, according to CompData's 2015 edition of their annual BenchmarkPro Survey, the total turnover across all industries was 16.7%.

### SUMMARY OF THE DISCLOSURE

The present disclosure, through one or more of its various aspects, embodiments, and/or specific features or sub-components, provides, inter alia, various systems, servers, methods, media, programs, and platforms for sourcing and recruiting candidates into an interview process. The various aspects, embodiments, features, and/or sub-components leverage and aggregate big data from across the web, allowing the prospective employers to directly target and recruit qualified talent instantly, leveraging verifiable and action-based aptitudes and skillsets.

According to an aspect of the present disclosure, a system for sourcing and recruiting candidates into an interview process is provided. The system comprises a processor and a memory. The memory includes instructions that, when executed by the processor, cause the processor to perform operations. The processor receives identifying information via an interface. The identifying information corresponds to at least one individual. At least one search parameter is determined based on the identifying information. The search parameter relates to a characteristic of the individual. A look-a-like profile is created using the search parameter. A search area of a network is determined, which defines a talent pool. Data from the search area of the network is searched based on the look-a-like profile via the interface. At least one look-a-like candidate is identified from the talent pool based on the search. The look-a-like candidate is different than the individual and has the characteristic in common with the individual. The look-a-like candidate is displayed on a display.

According to another aspect of the present disclosure, the processor accesses the characteristic of the individual via the network based on the identifying information and via the interface. The search parameter of the look-a-like profile is determined from the characteristic of the individual which is accessed via the network.

According to yet another aspect of the present disclosure, the identifying information includes a uniform resource locator, and the characteristic of the individual is accessed, via the network, via the uniform resource locator.

According to a further aspect of the present disclosure, the identifying information includes a username, and the characteristic of the individual is determined by searching the network for the username.

According to still a further another aspect of the present disclosure, the characteristic of the individual is determined from a found area of the network, and the search area of the network, which defines the talent pool from which the look-a-like candidate is identified, is the found area of the network from which the characteristic of the individual is determined.

According to another aspect of the present disclosure, the processor receives, via the interface, the characteristic of the individual in association with the identifying information.

According to yet another aspect of the present disclosure, the identifying information corresponds to a plurality of individuals, and the search parameter relates to an average of characteristics of the plurality of individuals.

According to a further aspect of the present disclosure, the identifying information corresponds to a plurality of individuals, and the search parameter relates to a range of characteristics of the plurality of individuals. The range is defined by a first characteristic of a first individual of the plurality of individuals and a second characteristic of a second individual of the plurality of individuals.

According to still a further another aspect of the present disclosure, the identifying information corresponds to a plurality of individuals, a plurality of the search parameter is determined based on the identifying information, a first search parameter of the plurality of the search parameter relates to a first characteristic of a first individual of the plurality of individuals, and a second search parameter of the plurality of the search parameter relates to a second characteristic of a second individual of the plurality of individuals.

According to another aspect of the present disclosure, the identifying information corresponds to a plurality of individuals, and the characteristic to which the search parameter relates is common amongst all of the plurality of individuals.

According to yet another aspect of the present disclosure, the processor contacts the look-a-like candidate to schedule an interview.

According to a further aspect of the present disclosure, the processor determines a likelihood of the look-a-like candidate scheduling the interview. In this regard, a plurality of the look-a-like candidate is identified, and a number of the plurality of the look-a-like candidate which is identified is increased or decreased in accordance with results of the determining.

According to still a further another aspect of the present disclosure, the processor, in determining the likelihood of the look-a-like candidates scheduling the interview, compares information of the look-a-like candidates with information of previous look-a-like candidates to determine the likelihood of the look-a-like candidates scheduling the interview.

According to another aspect of the present disclosure, the processor, before contacting the look-a-like candidate to schedule the interview, analyzes information of the look-a-like candidate to determine an appropriate manner for contacting the look-a-like candidate.

According to yet another aspect of the present disclosure, a plurality of the look-a-like candidate is identified, and the processor receives, via the interface, a total number of interviews in association with the identifying information. In this regard, the total number of interviews and the identifying information define a sourcing and recruiting process. The processor ends the sourcing and recruiting process when, in the contacting, an interviewing number of the plurality of the look-a-like candidate schedules the interview. The interviewing number is at least equal to the total number of interviews.

According to a further aspect of the present disclosure, the processor determines a likelihood of the look-a-like candidate leaving a current position. In this regard, a plurality of the look-a-like candidate is identified, and a number of the plurality of the look-a-like candidate which is identified is increased or decreased in accordance with results of the determination.

According to still a further another aspect of the present disclosure, the processor aggregates and evaluates the data from the search area of the network to identify the look-a-like candidate from the talent pool, with the data including information displayed at the search area, and the data being displayed in association with the look-a-like candidate.

According to another aspect of the present disclosure, the data from the search area of the network from which the look-a-like candidate is identified consists essentially of actionable data.

According to yet another aspect of the present disclosure, a method for sourcing and recruiting candidates into an interview process is provided. The method receives identifying information via an interface. The identifying information corresponds to at least one individual. At least one search parameter is determined based on the identifying information. The search parameter relates to a characteristic of the individual. A look-a-like profile is created using the search parameter. A search area of a network is determined, which defines a talent pool. Data from the search area of the network is searched based on the look-a-like profile via the interface. At least one look-a-like candidate is identified from the talent pool based on the search. The look-a-like candidate is different than the individual and has the characteristic in common with the individual. The look-a-like candidate is displayed on a display.

According to a further aspect of the present disclosure, a non-transitory computer-readable medium including a set of instructions for sourcing and recruiting candidates into an interview process is provided. The set of instructions, when executed by a computer, causes the computer to perform operations. The operations include: receiving identifying information, with the identifying information corresponding to at least one individual; determining, based on the identifying information, at least one search parameter, with the search parameter relating to a characteristic of the individual; creating, using the search parameter, a look-a-like profile; determining a search area of a network, with the search area of the network defining a talent pool; searching data from the search area of the network based on the look-a-like profile; identifying at least one look-a-like candidate from the talent pool based on the searching, with the look-a-like candidate being different than the individual and having the characteristic in common with the individual; and displaying the look-a-like candidate on a display.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system for sourcing and recruiting candidates into an interview process.

FIG. 2 illustrates an exemplary schematic of a workflow of a system for sourcing and recruiting candidates into an interview process.

FIG. 3 shows an exemplary job description of a system for sourcing and recruiting candidates into an interview process.

FIG. 4 shows an exemplary embodiment of a current recruitment ecosystem.

FIG. 5 shows an exemplary embodiment of a user profile for a system for sourcing and recruiting candidates into an interview process.

FIG. 6 shows an exemplary embodiment of a candidate profile for a system for sourcing and recruiting candidates into an interview process.

FIG. 7 shows a further exemplary embodiment of a candidate profile for a system for sourcing and recruiting candidates into an interview process.

FIG. 8 shows an exemplary list of effects of an embodiment of a system for sourcing and recruiting candidates into an interview process.

FIGS. 9A, 9B, and 9C show an exemplary list of features and objectives of an embodiment of a system for sourcing and recruiting candidates into an interview process.

FIG. 10 shows an exemplary workflow of a system for sourcing and recruiting candidates into an interview process.

FIGS. 11, 12, 13, 14, 15, 16, 17, 18, 19, 20, 21, 22, and 23 show various display screens of an executable program, recording on a computer-readable recording medium, for sourcing and recruiting candidates into an interview process.

FIG. 24 shows an exemplary list of traditional means for sourcing and recruiting talent.

FIG. 25 shows an exemplary solution for verifying a talent pool.

FIG. 26 shows an exemplary schematic of a search for candidate prospects according to an embodiment of the present disclosure.

FIG. 27 shows an exemplary schematic of a search for a candidate prospect according to an embodiment of the present disclosure

FIG. 28 shows a further exemplary schematic of a search for a candidate prospect according to an embodiment of the present disclosure.

FIGS. 29A, 29B, and 29C show exemplary profile information of candidate prospects according to embodiments of the present disclosure

FIG. 30 shows an exemplary schematic of a system for sourcing and recruiting at least one look-a-like candidate.

FIG. 31 shows an exemplary image of a log-in page for a system for sourcing and recruiting at least one look-a-like candidate.

FIG. 32 shows an exemplary image of an order page for a system for sourcing and recruiting at least one look-a-like candidate.

FIG. 33 shows an exemplary image of a blank new search page for a system for sourcing and recruiting at least one look-a-like candidate.

FIG. 34 shows an exemplary image of a completed new search page for a system for sourcing and recruiting at least one look-a-like candidate.

FIG. 35 shows an exemplary image of a first role information page for a system for sourcing and recruiting at least one look-a-like candidate.

FIG. 36 shows an exemplary image of a second role information page for a system for sourcing and recruiting at least one look-a-like candidate.

FIG. 37 shows an exemplary image of a confirmation page for a system for sourcing and recruiting at least one look-a-like candidate.

FIG. 38 shows an exemplary image of a results page for a system for sourcing and recruiting at least one look-a-like candidate.

FIG. 39 shows an exemplary image of an accepted candidate page for a system for sourcing and recruiting at least one look-a-like candidate.

FIG. 40 shows an exemplary image of a declined candidate page for a system for sourcing and recruiting at least one look-a-like candidate.

FIG. 41 shows an exemplary image of an interview declined page for a system for sourcing and recruiting at least one look-a-like candidate.

FIG. 42 shows an exemplary image of an interview accepted page for a system for sourcing and recruiting at least one look-a-like candidate.

FIG. 43 shows an exemplary image of an interview schedule page for a system for sourcing and recruiting at least one look-a-like candidate.

FIG. 44 shows an exemplary image of a collective role summary page for a system for sourcing and recruiting at least one look-a-like candidate.

FIG. 45 shows an exemplary image of a role status page for a system for sourcing and recruiting at least one look-a-like candidate.

FIG. 46 shows an exemplary image of a further role status page for a system for sourcing and recruiting at least one look-a-like candidate.

FIG. 47 shows an exemplary image of a role status page with look-a-like candidate contact information page for a system for sourcing and recruiting at least one look-a-like candidate.

FIG. 48 shows an exemplary image of a look-a-like candidate page for a system for sourcing and recruiting at least one look-a-like candidate.

FIG. 49 shows an exemplary image of a role agreement page for a system for sourcing and recruiting at least one look-a-like candidate.

FIG. 50 shows an exemplary image of a demo page for a system for sourcing and recruiting at least one look-a-like candidate.

FIG. 51 shows an exemplary image of a candidates page for a system for sourcing and recruiting at least one look-a-like candidate.

FIG. 52 shows an exemplary image of a further candidates page for a system for sourcing and recruiting at least one look-a-like candidate.

FIG. 53 shows an exemplary image of a specific candidate page for a system for sourcing and recruiting at least one look-a-like candidate.

FIG. 54 shows an exemplary image of a talent pool page for a system for sourcing and recruiting at least one look-a-like candidate.

FIG. 55 shows an exemplary image of a single talent page for a system for sourcing and recruiting at least one look-a-like candidate.

### DETAILED DESCRIPTION

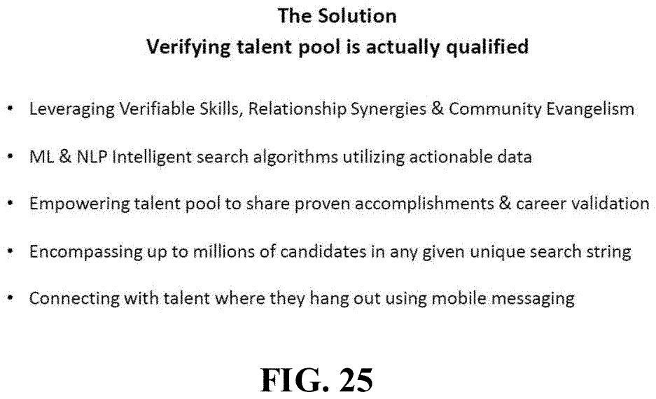

The present disclosure provides various embodiments for verifying whether a talent pool is actually qualified. As shown in FIG. 25, the various embodiments leverage verifiable skills, relationship synergies, and community evangelism. The embodiments employ machine learning (ML) and natural language processing (NLP) intelligent search algorithms which utilize actionable data. The embodiments empower talent pools to share proven accomplishments and career validation. The algorithms encompass up to millions of candidates in any given search string, and connect with the talent where it hangs out using, among others, mobile messaging. Thus, through one or more of its various aspects, embodiments and/or specific features or sub-components of the present disclosure, is thus intended to bring out one or more of the advantages as specifically described above and noted below.

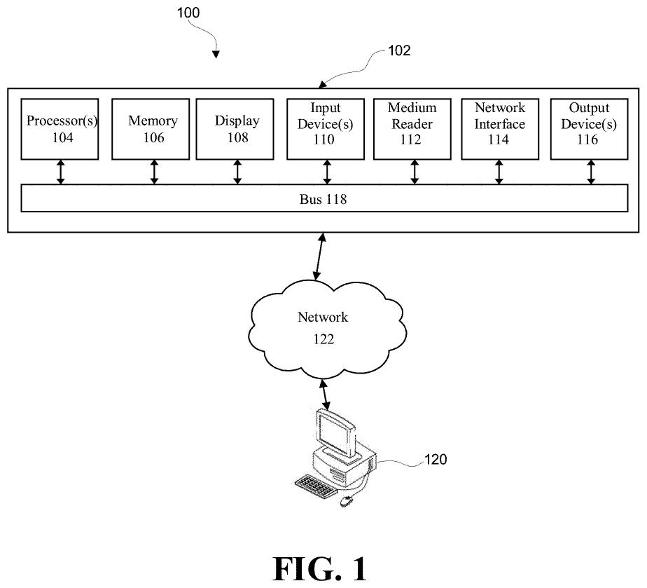

FIG. 1 is an exemplary system for use in accordance with the embodiments described herein. The server 102 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, a printer, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

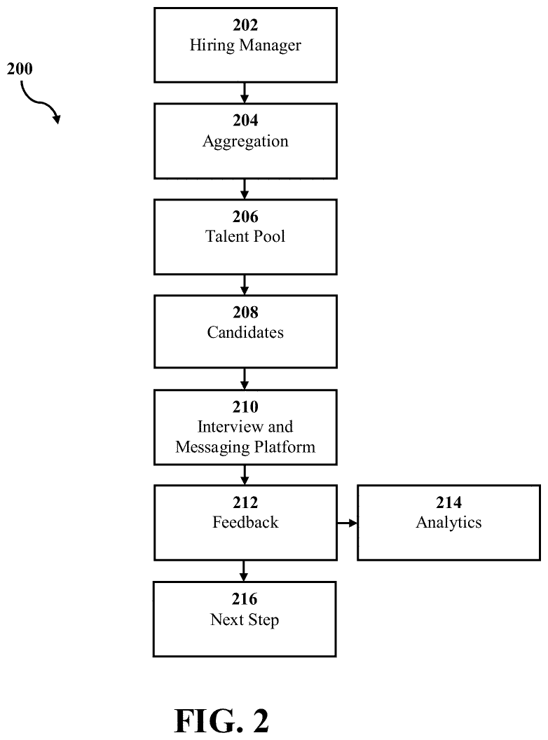

An exemplary schematic of a workflow for sourcing and recruiting candidates into an interview process is generally shown at 200 in FIG. 2. The workflow may be implemented by various configurations of the server 102 as described with respect to FIG. 1.

The workflow 200 allows for a hiring manager 202 of an employer to access the computer system 102. As described above, the computer system 102 may be, for example, a server. The computer system 102 is referred to hereafter as server 102 for convenience.

While the term hiring manager 202 is generally described herein as accessing the server 102, it is to be known and understood that any additional or alternative employee, representative, or agent of the employer may access the server 102. In other words, the hiring manage 202 is interchangeable with the terms employer, employee, representative, agent, and other similar terms in additional embodiments of the workflow 200. Also, while the terms hiring manager, employer, employee, representative, and agent are used in singular form, it is to be known and understood that the terms may be interchangeably used in plural form.

The hiring manager 202 accesses the server 102 via one of the additional computer devices 120. The additional computer device 120 may be, for example, a mobile computing device. The hiring manager 202 may be required to complete a log-in process as generally known and understood in the art in order to access the server 102. The hiring manager 202 may also be required to complete a separate registration process in addition to the log-in process. The registration process may require a monetary or other fee. The fee may be for a specific time period or for a predetermined number of accesses to the server 102 or searches on the server 102. Of course, additional and alternative fees as known and understood in the art may be applied for the registration process or the log-in process. For example, the fee may be reduced or waived altogether for a specific time period or for a predetermined number of accesses or searches

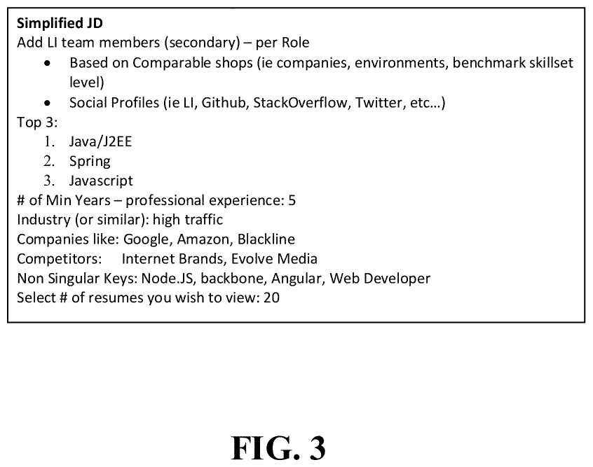

The hiring manger 202 may conduct a search for talent via the server 102. The search may be based on keyword input or one or more selections of job titles, criteria, and/or characteristics. The search may also be based on a geographic location and/or various other criteria as will be described herein. The geographic location may be determined based on user input or may be automatically determined. For example, the geographic location may be determined based on input of a zip code, identification of an Internet Protocol address, or identification of another identifier of the additional computer device 120 with which the hiring manager accesses the server 102. For example, the geographic location may be determined based on geolocation of the additional computer device 120 or by any other known and understood method or standard. The search may further include additional or alternative fields, such as but not limited to, minimum years of experience, industry, work experience, etc. Anon-limiting and exemplary talent or job description is shown by FIG. 3. Of course, information listed in the talent or job descriptions shown by FIG. 3 are merely exemplary and not limiting or exhaustive. The talent or job description may additionally or alternatively include a statement or blurb relating to the role or position, a term or scope of the role or position, a role or impact, company or team size, breakdown of company or team size, reasons for hiring, top three must-haves, onsite or telecommuting availability, at home or abroad, new division vs. maintenance, etc. Again, these items are merely exemplary and are not limiting or exhaustive.

The search may additionally or alternatively be based on the selection or identification of a role, which is to be filled, by the hiring manger 202. The role, or position, may be selected from a skill folder or bucket by the hiring manager 202. The role may be predefined or created, and potentially saved, by the hiring manager 202. In this regard, the role may be selected from a drop-down menu, from which roles may be added or removed by the hiring manager 202 and/or the server 102. The role may be associated with search criteria in advance, or the hiring manger 202 may specify the search criteria upon selection of the role. When the role is associated with search criteria in advance, the search criteria may be editable for providing flexibility to the hiring manager 202, or the search criteria may be fixed for providing efficiency to the server 102. Of course, the above-described examples and methods of selecting the role are merely exemplary and are not limiting or exhaustive. In any event, the role may comprise, or be associated with, the search criteria.

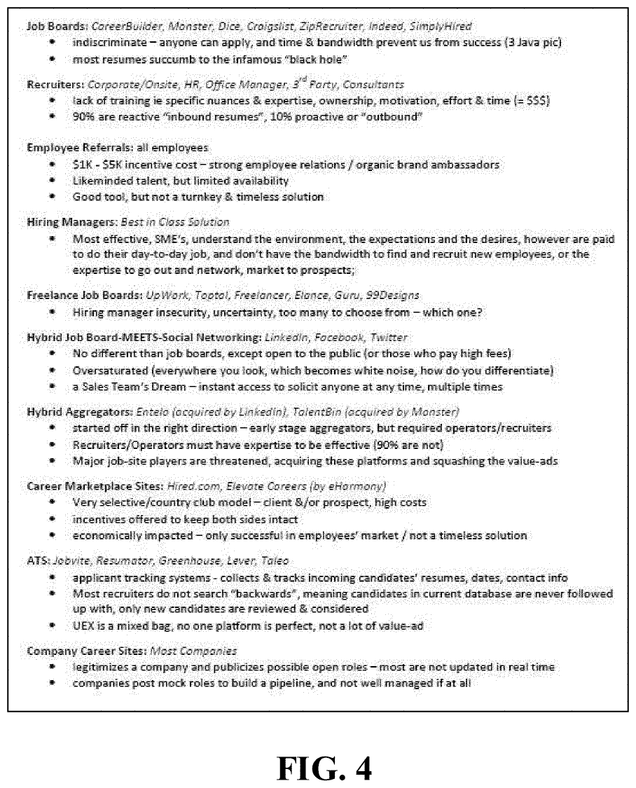

Upon receipt of search criteria from the hiring manger 202, the server 102 performs an aggregation 204 of big data from across a network to define a search area. The search area defines a talent pool 206, from which candidates 208 are identified. Accordingly, the server leverages and aggregates the big data to allow the hiring manager to directly target and recruit prospects instantly, leveraging verifiable and action-based aptitudes and skillsets. The aggregation 204 comprises a reverse job board ideology which turns traditional recruitment 180 degrees. Such a platform or ideology is defined as action versus reaction, or pro-active versus reactive. Said another way, the platform or ideology is 100% outbound, as compared with inbound. In contrast, traditional recruitment is 95% reactive. That is, in the current ecosystem, a job is often posted on the internet and made available to the public, with more jobs seemingly being sent to someone as a recommendation or suggested opportunity nowadays. An exemplary schematic of the current recruitment ecosystem is shown by FIG. 4.

Under the current recruitment ecosystem, anyone can apply for a posting indiscriminately. Unfortunately, recruiters or hiring managers do not have the training, ability, or bandwidth to be able to manually filter and select the appropriate candidates. That is, the recruiters or hiring managers simply do not have the time to perform manual filtering and selection efficiently and effectively, and to also arrange and conduct interviews, without making mistakes or creating a negative user experience. The embodiments of the server 102 described herein, however, allow the search criteria, upon which a position may be defined to actually have a mind of their own and target candidates that are appropriate. The embodiments do not target individuals that do not meet the requirements and are not appropriate. The resultant search is not available to the public.

The network of which the aggregation 204 is performed may comprise the World Wide Web, the internet, an intranet, a local area network, a wide area network, or any other network or web which is commonly known and understood in the art. For example, the network may be the network 122 as described with respect to FIG. 1.

The aggregation 204 of the network may be based on the search criteria. The aggregation 204 may also be based on the geographic location. For example, the areas of the network which are aggregated may be limited to being within the geographic location or within a predetermined distance of the geographic location. Additionally or alternatively, the areas of the network which are aggregated may have a sliding scale relationship with the geographic location. That is, the geographic location or distance therefrom may be expanded for higher quality areas. The opposite may also be true. That is, the geographic location or distance therefrom may be decreased for lower quality areas.

The network may be openly searched based on the search criteria input by the hiring manger 202 to define the areas which are to be aggregated. For example, the network may be searched via a search engine associated with the network. Additionally or alternatively, pre-defined areas or locations of the network may be searched. For example, specific top-level domains or hostnames may be searched. Specific uniform resource locators and websites may additionally or alternatively be searched. The areas or locations of the network which are aggregated may be specified by the hiring manger 202 or the server 102. The hiring manger 202 may input or select the areas or locations of the network to define the talent pool 206 from which to search. The talent pool 206 may comprise, for example, prospects for recruitment. In this regard, the terms talent pool, prospects, candidates, candidate prospects, as well as other similar terms are used interchangeably herein. The server 102 may determine the areas or locations of the network in which to search based on the search criteria and/or the geographic location, or also based on preexisting relationships with the areas or locations.

For example, GitHub is source code repository. If the hiring manger 202 is searching for a Java developer, the hiring manger 202 may input or select GitHub as an area or location to define the talent pool 206 from which to search. Additionally or alternatively, the server 102 may determine or suggest GitHub as an area or location to define the talent pool 206. The server 102 may determine or suggest GitHub as an area or location based on conducting an open search on a search engine, or the server 102 may reference an internal database to determine the area or location. The database may be, for example, the memory 106 of FIG. 1. The database may be manually provided with areas or locations to define the talent pool 206, such as GitHub. Additionally or alternatively, the database may be self-updating or utilize machine learning. For example, as will be more apparent from the disclosure below, the server 102 may determine that a candidate 208 for a Java developer position, which is selected from among the talent pool 206, uses GitHub based on a profile of the candidate 208. If GitHub is a previously unknown or unidentified area or location for Java developers, when the candidate 208 is discovered or if the candidate 208 receives positive feedback from the hiring manager 202, the server 102 may associate GitHub as a valuable resource for Java developers and add the area or location to the database. In other words, the server 102 may use profile information of desirable candidates 208 to update and render the database current.

When the area or location of GitHub is newly discovered as a valuable resource, the server 102 may associate GitHub with a tag based on the search criteria of Java developer. The server 102 may also add the area or location of GitHub to the database with a priority score or a temporary label. The priority score or the temporary label may be increased or removed upon uncovering additional candidates 208 which identify GitHub in their profiles. Thus, the server 102 improves its learning capabilities by referencing the profiles of multiple candidates 208.

Of course, the above-examples are merely exemplary and are not meant to be exhaustive or limiting. For example, any additional areas or locations may be added to the database by searching profiles of registered users or members of the server 102. The areas or locations may be added to the database when a predetermined number of users or members list the areas or locations in their profiles, or when users or members of a sufficient level list the areas or locations in their profiles. Moreover, it is to be known and understood that the reference to GitHub above is merely exemplary and that additional or alternative areas may also be used to define the talent pool 206 and/or stored in the database. Also, while GitHub is generally referenced as a singular website, it is to be known and understood that plural websites and/or other locations may be used to define the talent pool 206 based on a single set of search criteria. FIG. 4 lists several additional exemplary websites and locations which include areas for defining the talent pool 206 which may be searched for candidates 208. The candidates 208 may refer to selected ones of the talent pool 206 or prospects. In other words, the candidates 208 are selected candidates.

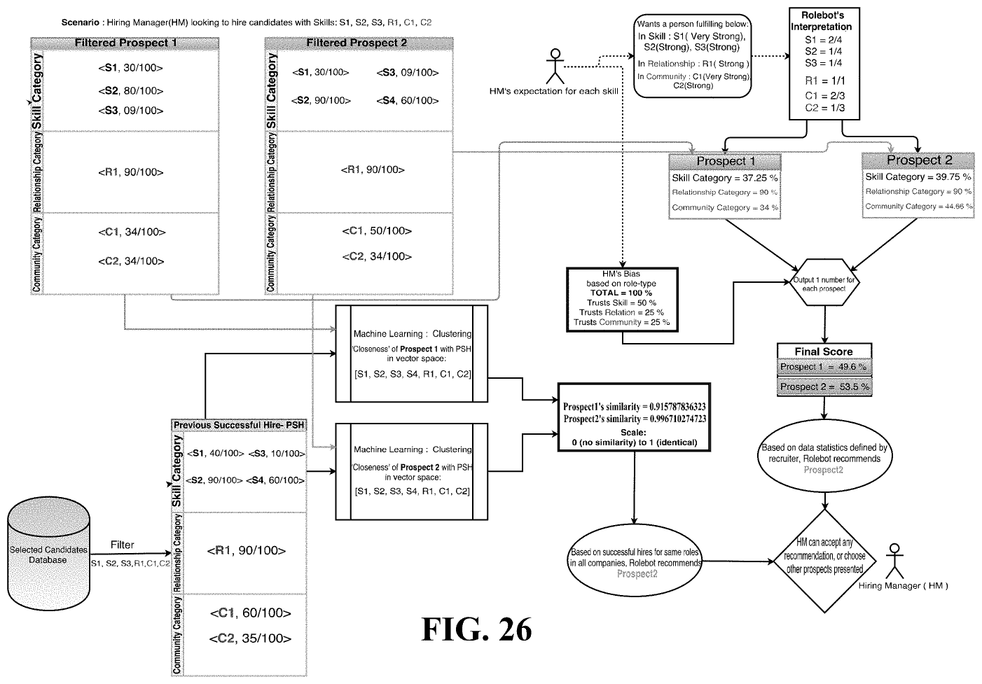

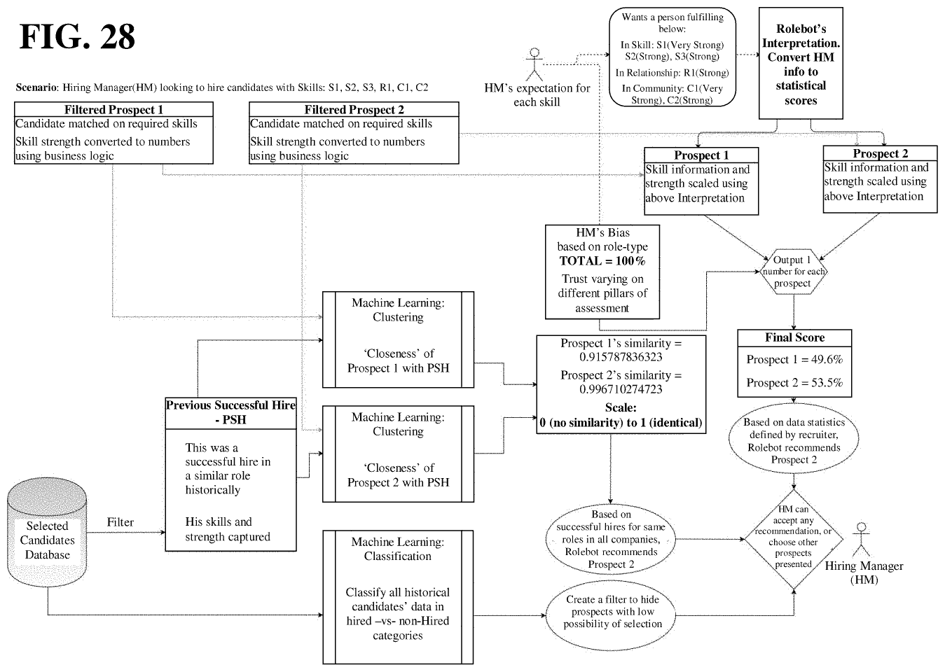

The areas or locations of the network, which may be determined based on the search criteria and/or the geographic location, define the talent pool 206. The talent pool 206 within the areas or locations of the network is searched for candidates 208. For example, regarding the exemplary location of GitHub, the users of the website comprise the talent pool 206. The talent pool 206 may be further limited based on the search criteria and/or the geographic location. For example, the talent pool 206, or users or members of the areas of the network identified in the aggregation 204, may be further limited to being within the geographic location or within a predetermined distance of the geographic location. Additionally or alternatively, the talent pool 206 which is to be searched or returned may have a sliding scale relationship with the geographic location. That is, the geographic location or distance therefrom may be expanded for higher quality talent. The opposite may also be true. That is, the geographic location or distance therefrom may be decreased for a lower quality talent. In any event, the users may be limited or filtered based on the search criteria and/or the geographic location, or the entirety of the users or members of the website or areas of the network identified in the aggregation 204 may be evaluated as the talent pool 206. Exemplary embodiments and algorithms for searching the talent pool during the aggregation are described herein, such as with respect to FIGS. 26, 27, and 28.

The areas or locations of the network, which define the talent pool 206, may be searched in real-time or near real-time based on the search criteria and/or the geographic location. Additionally or alternatively, the areas or locations of the network may be searched in advance, with results of the search being stored in a database. In such embodiments, the talent pool 206 may be wholly or partially contained within the database. The talent pool 206, as contained in the database, may be sorted, categorized, filtered, and/or otherwise organized prior to being searched by the search criteria and/or the geographic location. The talent pool 206 may be sorted, categorized, filtered, and/or otherwise organized in accordance with any of the manners described herein or as otherwise understood in the art.

The talent pool 206, as contained in the database, may be systematically updated. The database may be, for example, updated every predetermined time period. In this regard, the database may be updated with respect to each of the areas or locations of the network at a same time, or the database may be update for the different areas or locations of the network at different times. Further, in additional or alternative embodiments of the present application, the database may be wholly or partly updated based on whether an amount of users, traffic, content, or data at the areas or locations of the network exceeds a predetermined amount, or increases by a predetermined amount, since a last update. When one of the areas or locations of the network exceeds or increases by the predetermined amount of the identified or other criteria, that area or location of the network may be updated. Alternatively, all of the areas or locations of the network may be updated at such timing. Even further, a portion of the areas or locations of the network may be updated, such as, for example, a portion of the areas or locations of the network having a highest priority or ranking may be updated. Of course, the above-described examples are merely limiting and not exhaustive. The database may be updated in accordance with any additional or alternative methods without departing from the scope of the present disclosure. Further, while the database is described in singular form, the database may comprise a plurality of databases or other storages. In such embodiments, the talent pool 206 may be organized, sorted, or otherwise classified amongst the databases.

The talent pool 206 is evaluated based on the contents of the areas or locations of the network. For example, the areas or locations of the network may be searched for publications, speaking engagements, questions posted, questions answered, code posted, ratings, achievements, abilities, or any other content which may be included within the areas or locations of the network. Again with respect to the code repository website of GitHub, the projects includes therein may comprise the contents which are searched. The searched content is associated with the users related thereto, such that the talent pool 206 consists of the users who are active or engaged on the areas or locations of the network, e.g., users who are active or engaged on GitHub. In this regard, “actions speak louder than words.” That is, the users' actions within the areas or locations of the network are associated with the users to provide evaluations thereof. Accordingly, the talent pool 206 may comprise the users which are identified by the areas or locations of the network via their actions.

In this regard, the system 102 performs “evidence based searching” at the areas or locations of the network. The talent pool 206 is identified from such areas or locations of the network based on evidence or other actionable data, which may be considered factual, instead of based on unverified statements which may be made by the talent pool 206, or another party, as in conventional recruitment and hiring processes. The searching may not be keyword based, but rather, relies upon specific actions which may be undertaken by the talent pool 206 at, or by means of, the areas or locations of the network.

The users of the talent pool 206 may be identified by name or username. If the users are identified by username, the server 102 may conduct a search for the username on the areas or locations of the network, or on any additional networks described herein, in order to identify a name associated with the username. Additionally or alternatively, the server 102 may obtain a name associated with the username via cooperation of the area or location in which the username is included. The server 102 may maintain a database of names and associated usernames and/or aliases, from which it may also determine a name associated with a username. The database may be, for example, the memory 106 of FIG. 1. Of course, the examples described above are merely exemplary and are not limiting or exhaustive. The server 102 may determine names associated with usernames via any additional or alternative known methods. For example, the server 102 may search profiles of its users or members to match usernames with names. The names may comprise any combination of a first name, a middle name, a middle initial, a last name, a given name, a surname, a family name, or any other name commonly known and understood.

The users of the talent pool 206 may be evaluated, via the contents of the areas or locations of the network, based a single criteria or several criteria. The criteria may be predetermined by the server 102 or specified by the hiring manger 202. The hiring manager 202 may, for example, select criteria from amongst a plurality of predetermined criteria.

While the embodiments of the server 102 described herein specify that the hiring manger 202 specifies the search criteria, the network need not be specifically searched for the search criteria provided by the hiring manager 202. That is, in some embodiments, the hiring manager 202 may specify a certain title or skills for which to search, with the network being openly and directly searched based on the search criteria input by the hiring manger 202. In other embodiments, the server may derive the criteria based upon information which the network is to be searched for from the search criteria provided by the hiring manager 202. For example, from the search criteria provided by the hiring manager 202, the server 102 may derive a title and/or skills, with the network being openly and indirectly searched based on the search criteria input by the hiring manger 202.

According to such embodiments in which the network is openly and indirectly searched based on the search criteria input by the hiring manger 202, the server 102 may allow the hiring manger 202 to specify titles and/or skills which are commonly and/or traditionally used in the relevant industries. The server 102 may, nevertheless, adaptively and/or continuously modify the actual criteria upon the network is searched. In this regard, the server 102 is able to update its processes without requiring the hiring managers 202 to similarly adapt. In other words, a level of artificial intelligence may be implemented by the server 102 to constantly and continuously refine the actual criteria upon which the network is searched while not requiring the hiring manager 202 to similarly adapt.

In an embodiment of the server 102, the criteria may include any combination of five pillars, including: (1) a self-score pillar; (2) a skill set pillar; (3) a community pillar; (4) a relationship pillar; and (5) an interview/review pillar. The criteria by which the users of the talent pool 206 are evaluated are generally referred to hereinafter as pillars for convenience.

Each pillar may be associated with a score, percentage, rank, classification, or other grade. The pillars are described hereinafter as being associated with a score for convenience. Nevertheless, the pillars are not to be interpreted as being associated with only a score and it is to be understood that the pillars may be associated with any of the above-mentioned evaluations or similar terms. Moreover, it is to be known and understood that a certain pillar may be associated with one evaluation, such as a score, while other pillars are associated with different evaluations, such as a percentage and a rank.

The score for each pillar may be determined based on aggregate or cumulative content of all searched areas or locations of the network. For example, each piece of content which corresponds to a relevant pillar may increase or otherwise affect the score of that pillar. Additionally or alternatively, the score may be determined based on an average or mean of the content of searched areas or locations of the network. For example, when the score is associated with a number of likes, the number of likes may be averaged over multiple postings. The average or mean may be determined for each searched area or location of the network individually, or the average or mean may be determined across all searched areas or locations of the network in total. That is, the server 102 may determine an average number of likes for posts on each of plural websites, or the server 102 may determine and average number of likes for posts across all of the websites. Of course, the above examples are merely exemplary and not limiting or exhaustive. For example, the scores may be determined based on a highest or lowest score of the content for each area or location individually, or for all areas or locations in total.

The server 102 may also filter pieces of content for a user. The server 102 may filter the pieces of content to improve accuracy and/or to prevent fraud or manipulation of the system. For example, the server 102 may filter pieces of content which include outlying scores. That is, if a user is associated with plural pieces of content which are highly regarded in a community and associated with one piece of content which is lowly regarded in the community, the server 102 may disregard the lowly piece of content as potentially being associated with a different user or as being an anomaly.

The server 102 may also filter pieces of content based on timestamps and/or locations of the pieces of content. For example, if a user is not associated with any piece of content for a first, e.g., longer, time period but is then associated with plural pieces of content during a second, e.g., shorter, time period, the server 102 may group the plural pieces of content and/or disregard some or all of the plural pieces of content. As a result, a user which is inactive within a community may not receive a high score for participating in a single, active debate or other discussion. Such an embodiment would also prevent a user from manipulating his or her score, such as when the user becomes unemployed.

As an additional example, the server 102 may identify geotags or metadata associated with plural pieces of content to determine whether the plural pieces of content are likely associated with a same user. If the geotags or metadata indicate that plural pieces of content are from one location while one piece of content is from another distant location, the server 102 may disregard the one piece of content. However, if all of the pieces of content are from different locations, the server 102 may determine that the user is a frequent traveler and/or uses different proxy servers. As a result, the server 102 may maintain the pieces of content. Even further, if the server 102 determines that pieces of content of a user are anonymized, the server 102 may disregard the content and/or the user as being untrustworthy. That is, the server 102 may exclude the user from the candidates 208.

Even further to the above, in embodiments of the present application, the system may consistently, intermittently, or constantly tweak or modify the method, manner, or algorithm upon which the scores are determined. In such an embodiment, users would be further prevented from manipulating the server 102.

With respect to the self-score pillar mentioned above, just as the hiring manager may log-in to and/or register with the server 102, individuals who may be interested in potential employment or recruitment may complete a log-in process and/or registration process with the server 102. The log-in process and/or registration process of the individual may be similar to the processes described above or as generally known and understood in the art. In this regard, the individual may complete a member profile. The member profile may include, among others, a name, any usernames, any aliases, personal information, education information, and employment information. The individual may even be permitted to upload a resume and/or to list websites, areas, or locations of interest. The server 102 may use the member profile to associate a username with the individual, as described above. The server 102 may also use the member profile to automatically update the database of locations or areas, also as discussed above.

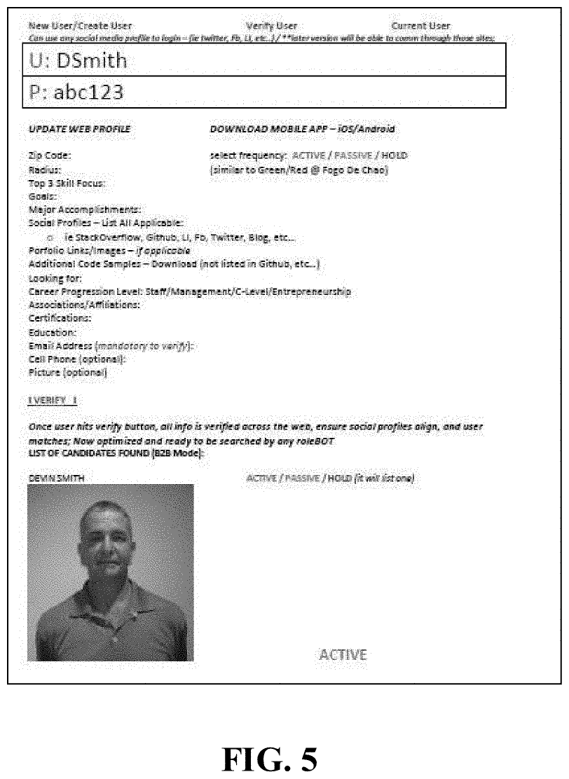

A non-limiting and exemplary embodiment of a member profile is shown by FIG. 5. In embodiments of the server 102, a top portion of the member profile of FIG. 5 may comprise a business-to-consumer (B2C) portion. The top portion may also comprise be available via mobile interface only, whereupon all members will download a mobile application and be able to configure the profile via a mobile device. The mobile application may be available across any platforms including, but not limited to, Android, iOS, and Responsive Design. Of course, the above-described and shown profiles are merely exemplary and may include any additional or alternative information or features as known and understood in the art. In any event, the member profile may be used to provide the self-score pillar evaluation. The self-score pillar evaluation, however, is generally indicative of words and not actions. That is, the individual generally provides the information upon which the self-score pillar evaluation is based. As a result, this pillar may be more susceptible to manipulation and deceit, and thus, may be regarded less highly than the other pillars.

The skill set pillar may be based on pieces of content from the areas or locations of the network which relate to rankings within the areas or locations, or popularity within the areas or locations. For example, the skill set pillar may be based on a code proficiency ranking, a number of questions answered by a user, likes or dislikes for comments provided by the user from other users of the areas or locations of the network. Of course, these examples are merely exemplary and are not limiting or exhaustive.

The community pillar may be based on pieces of content from the areas or locations of the network which relate to questions answered by a user, a quantity of information contributed to the areas or locations of the network, publications made available to the areas or locations of the network, presentations made on or referenced as being made by the areas or locations of the network, presentations attended on or referenced as being attended by the areas or locations of the network, meet-ups attended on or referenced as being attended by the areas or locations of the network, etc. In other words, the community pillar is a reflection of how active a user is in the community or in the areas or locations of the network. For example, with respect to the above-mentioned website of GitHub, the community pillar may include a number or quantity of code contributed as well as possibly a level of use of the contributed code amongst the community and/or an evaluation of the code by the community. In this regard, in an alternative embodiment of the present application, the level of use of the contributed code amongst the community and/or the evaluation of the code by the community may be under the skill set pillar as they may be indicative of a level of skill of the user. In any event, as should be clear from the above, embodiments of the present application may include overlap of classification of the pieces of content. The pieces of content may even be applied to plural pillars. Nevertheless, it should again be understood that the above-described examples are merely exemplary and not limiting or exhaustive.

The relationship pillar may include the existence of any relationship between the hiring manager and/or the employer for which the hiring manager is engaged in a hiring process and a user of the talent pool 206. When entering the search criteria or completing a member profile, the hiring manger may identify the employer, any information related to the employer, any employees of the employer, and/or any information related to the employees of the employer. The server 102 may then search the areas or locations of the network to determine whether any users in the talent pool 206 have a preexisting or other relationship with the employer, employees, or other information. For example, the server 102 may determine whether a user of the talent pool 206 has previously worked at a same place of employment as an employee of the employer. The server 102 may additionally or alternatively determine whether a user of the talent pool 206 previously attended a same school as an employee of the employer. The server 102 may even search social networking websites, applications, or platforms to determine whether any social connection exists between a user of the talent pool 206 and an employee of the employer. Such identification under the relationship pillar may allow for easier vetting of a user of the talent pool 206. As a result, the server 102 may label a user of the talent pool 206 as a candidate 208 when the user has a high relationship score, even when scores of the other pillars may be lacking or substandard.

The interview/review pillar may comprise reviews of interviews previously conducted with users of the talent pool 206. That is, as will be discussed below, qualified users of the talent pool 206 may be identified as candidates 208. The candidates 208 may be afforded opportunities to communicate, and even interview, with the hiring manager 202. The hiring manager 202 may then provide feedback or reviews of the candidates 208. In embodiments of the present application, such feedback and reviews provided by the hiring manager 202 may only be available to other hiring managers 202. As a result, the interview/review pillar may provide internal, uninfluenced scores of users of the talent pool 206.

A same set of areas or locations of the network may be searched for all of the above-mentioned pillars, or different areas or locations of the network may be searched for different pillars. For example, social networking websites may be searched for the relationship pillar but not the skill set pillar. Instead, code repository websites may be searched for the skill set pillar, but not for the relationship pillar. The server 102 may have non-existent, pre-existing, or independent relationships with the areas or locations of the network which are searched. In this regard, since users may receive employment and recruitment opportunities by visiting and participating at the areas or locations of the network, the areas or locations of the network may be incentivized to establish a relationship with the server 102. Along these lines, the server 102 may utilize application programming interfaces (APIs) of the areas or locations of the network to facilitate searching of the areas or locations for the pieces of content. The APIs may public, or bargained for via the incentive to establish the relationship with the server 102.

After reviewing and evaluating the talent pool 206 defined by the areas or locations of the network, candidates 208 are identified from among the talent pool 206 for presentation to the hiring manager 202. In embodiments of the present application, a predetermined number of candidates 208 may be presented to the hiring manager 202, highest scoring users of the talent pool 206 over all pillars may be presented to the hiring manager 202 as the candidates 208, highest scoring users of the talent pool 206 from each pillar may be presented to the hiring manager 202 as the candidates 208, or the candidates 208 may be determined in accordance with any other known and understood criteria. The candidates 208 may be selected based on criteria set by the system, or the candidates 208 may be selected based on criteria set by the hiring manager 202. In certain embodiments, a membership level of the hiring manager 202 may affect the ability to set the criteria upon which selection of the candidates 208 is based or a number of the candidates 208 which may be presented. In any event, candidates 208 are selected from amongst the talent pool 206 and presented to the hiring manager 202 based on the searching of the areas or locations of the network and the evaluations of the pillars.

In embodiments of the present application, the talent pool 206 and/or the candidates 208 may be filtered and/or verified before and/or after being searched, reviewed, and/or evaluated.

For example, the talent pool 206 and/or the candidates 208 may be filtered based upon titles. Traditionally, titles have been a primary means upon which candidates are evaluated. Recruiters and/or hiring managers have become accustomed to using titles. As a result, the talent pool 206 and/or the candidates 208 may be filtered based upon at least one title. The titles may be, for example, a position held within a company, an educational level or degree, a professional certification, a particular skill or project, or any other title commonly known and understood in the art. Such titles may be included within information in the areas or locations of the network which are searched by the server 102. Specifically, the titles may be in information provided by the talent pool 206 and/or the candidates 208. In other words, the titles may be unverified by the server 102. Alternatively, the server 102 may perform a verification process to verify the titles that are included within the information in the areas or locations of the network which are searched by the server 102. The server 102 may verify the titles by searching the same or different areas or locations of the network.

The server may filter the talent pool 206 and/or the candidates 208 based on having and/or not having a certain title. The certain title may be required to be verified or unverified. Whether the title is required to be verified or unverified may be determined by the hiring manager 202, or may be determined by the server 102. The server 102 may, for example, accept a title without a positive verification when it is supported by a predetermined amount of additional information, and or when it is obtained from an area or location of the network which has a predetermined level of trust or integrity. For example, when the area or location of the network is associated with a certified, registered, or otherwise established entity, the title may be accepted without verification. The title may also be accepted without verification when it is obtained from certain portions or includes certain identifying information within the area or location of the network. That is, if the title is obtained from information published by the entity, it may be accepted. However, if the title is obtained from a comments section or information that is not otherwise posted by the entity, it may not be accepted. In any event, the talent pool 206 and/or the candidates 208 may be filtered based on having and/or not having at least one title based on any additional or alternative methods which are known and understood without departing from the scope of the present application.

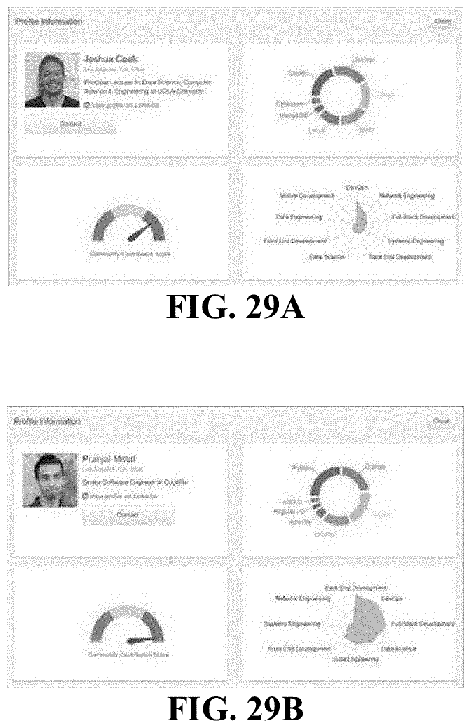

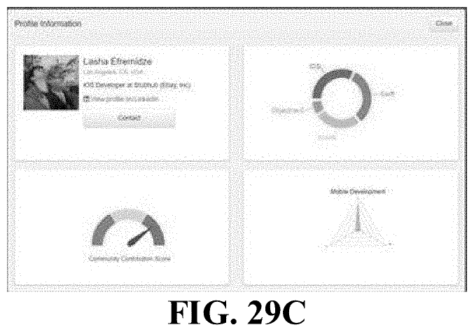

The server 102 may additionally or alternatively assign a score or weighting to the titles. Weightings or scores of the titles may be displayed in, for example, a pie or ring graph and/or a spider graph, as shown in FIGS. 29A, 29B, and 29C. As shown in FIGS. 29A, 29B, and 29C, the weightings or scores of the titles may be shown for each member of the talent pool 206 and/or the candidates 208 for a plurality of different titles. In such embodiments, the different titles may each be specified by the hiring manager 202, one of the titles may be specified by the hiring manager 202, or none of the titles may be specified by the hiring manager 202. The titles which are not specified by the hiring manager 202 may be determined by the server 102 based on the search criteria input by the hiring manager 202, and/or based on the information searched of the talent pool 206 and/or the candidates 208 in the areas or locations of the network.

In one exemplary embodiment, for example, one of the titles may be specified by the hiring manager 202 and/or determined by the server 102 based on the search criteria input by the hiring manager 202. Such title may be shown in a graph weighted or scored against similar titles, determined by the server and/or specified by the hiring manager 202. As such, the hiring manager 202 may be able to visually determine whether a member of the talent pool 206 and/or one of the candidates 208 is best suited for the initially specified or determined one of the titles, and to also visually determine whether the member of the talent pool 206 and/or the one of the candidates 208 is suited or qualified for another title. According to such exemplary embodiment, the diversity or cross-title applicability of the members of the talent pool 206 and/or the candidates 208 may be easily determined. Thus, the hiring manager 202 is able to grasp the skills and/or positions to which the members of the talent pool 206 and/or the candidates 208 may be able to contribute.

In additional or alternative embodiments of the present application in which the talent pool 206 and/or the candidates 208 are filtered, the talent pool 206 and/or the candidates 208 may be filtered according to a diversity feature. For example, the talent pool 206 and/or the candidates 208 may be filtered according to gender, race, religion, ethnicity, nationality, physical characteristics, and/or any other defining trait which is known and understood. According to such feature, the hiring manager 202 may easily satisfy any diversity requirements and/or promote diversity.

In even further additional or alternative embodiments of the present application in which the talent pool 206 and/or the candidates 208 are filtered, the talent pool 206 and/or the candidates 208 may be filtered according to a leadership feature. The leadership feature may require a certain level of experience in a field or skill specified by the hiring manager 202 or determined by the server 102. The certain level of experience may include a predetermined number of years of experience, a predetermined number of completed projects, an ascent to a certain level within an organization or entity, a predetermined amount or time of managerial experience, or any additional level of experience which is generally known and understood.

In still even further additional or alternative embodiments of the present application in which the talent pool 206 and/or the candidates 208 are filtered, the talent pool 206 and/or the candidates 208 may be filtered based on certifications and/or associations. The certifications and/or associations may be professional and/or recreational. The certifications and/or associations may be specified by, for example, the hiring manager 202. For example, the certifications and/or associations may include a Professional Association of Diving Instructors (PADI) certification. In this regard, the server 102 may identify members of the talent pool 206 and/or the candidates 208 which are listed within a database of registered PADI certifications. Of course, the above-described example is merely exemplary and not limiting or exhaustive. Additional or alternative certifications and/or associations may be used without departing from the scope of the present application. Although not required, the certifications and/or associations may be included within a national, regional, or other database.

Further, while the above-described filter is described as relating to certifications and/or associations, it may further include hobbies or social activities which do not require verification or registration. For example, if a hobby of knitting is searched for, the areas or locations of the network may be searched for posts, comments, or transactions relating to knitting. The transactions may be searched for by, for example, searching online exchanges to determine items for which the talent pool 206 and/or the candidates 208 are transacting, either buying, selling, giving, receiving, or browsing. According to the above-described feature, candidates 208 having similar or diverse interests from the hiring manager 202 or its associated employees may be identified.

The talent pool 206 and/or the candidates 208 may additionally or alternatively be required to be verified in a predetermined context. For example, the talent pool 206 and/or the candidates 208 may be required to be verified in a gaming context. That is, the talent pool 206 and/or the candidates 208 may be required to have achieved a certain level or ranking in a particular game, a certain level or ranking on a particular platform, and/or have a certain number of followers on such game and/or platform. Of course, these examples are merely exemplary and not limiting or exhaustive. Also, the talent pool 206 and/or the candidates 208 may be required to be verified in additional or alternative contexts. For example, the talent pool 206 and/or the candidates 208 may be required to have a certain status or number of followers on a social media platform. According to such embodiments, the talent pool 206 and/or the candidates 208 are easily able to be verified within the specified context(s), as it would be difficult for a prospect to “fake” a gamer ranking and/or a number of followers. It would again also enable the hiring manager 202 to find candidates 208 having similar or desired interests.

The above-described filters and verifications may be applied individually or in combination. As a result, different data sets and candidates 208 may be brought together. For example, candidates which are both engineers and gamers may be searched for. As an additional example, a data set may be filtered to find chess players which are PADI certified and also enjoy knitting.

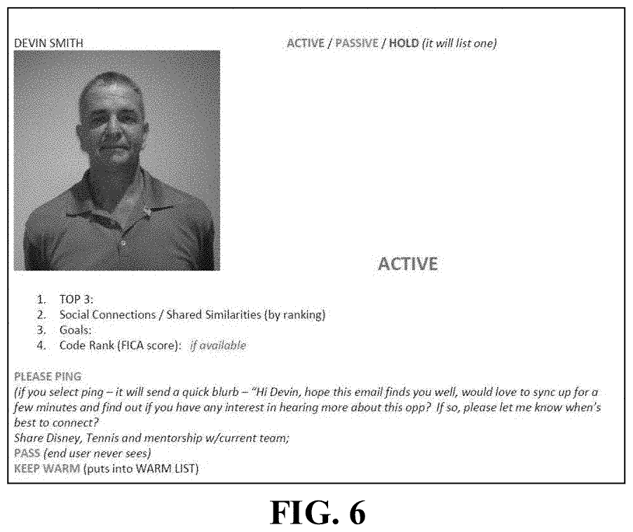

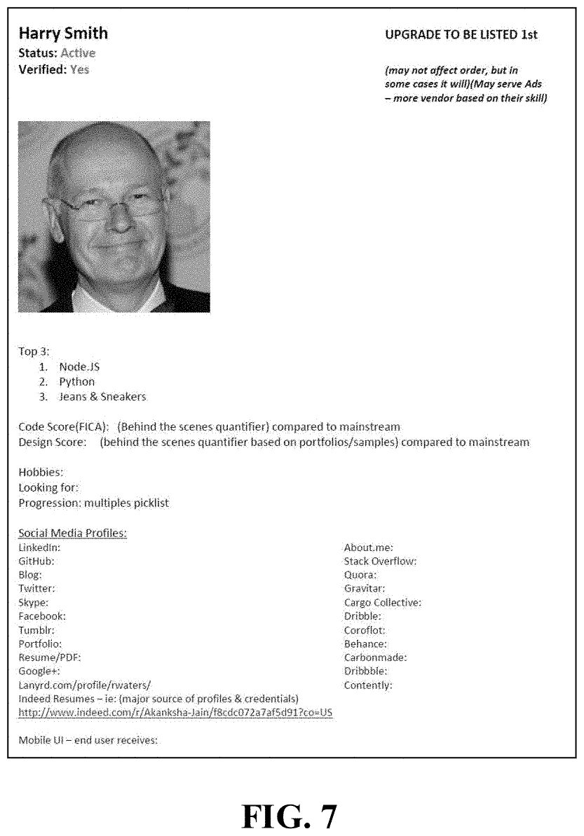

Non-limiting and exemplary embodiments of candidate profiles of candidates 208 are shown by FIG. 6 and FIG. 7. As shown in FIG. 6, a candidate profile may include an indication of whether a candidate 208 is in an active, passive, or hold state. When the candidate 208 is a member of the system, the member may set his or her profile to one of the active, passive, or hold states. When the member is in the active state, the member is actively looking for employment or recruitment opportunities. When the member is in the passive state, the member is passively looking for employment or recruitment opportunities. That is, while the member is not looking for employment, the member may be interested in hearing about opportunities. When the member is in the hold state, the member is holding steady with his current position and is not interested in employment or recruitment opportunities. In the hold state, the member may even be made private. That is, the member's information may be excluded from the candidates 208. Such state information which may be set by the member avoids unnecessary expenditure of resources by the hiring manager 202 and the candidate 208.

Also as shown in FIG. 6, the hiring manager 202 has an option to ping, pass, or keep warm with respect to a candidate 208. When the hiring manager 202 elects to ping the candidate 208, a message is sent to the candidate 208. The message may be predetermined by the server 102 or the hiring manager 202. Additionally or alternatively, the message may be customizable by the hiring manager 202. The message may comprise a voice message, electronic mail message, text message, or any other message commonly known and understood in the art. In embodiments of the server 102, all communication may be done through agnostic messaging platforms such as, but not limited to, Twitter, Kik, Facebook, Direct Text Messaging, or any other mobile application. In such embodiments, as described above, location may be tracked via geolocation technology in lieu of zip codes or stated city and state. As a result, the above-functions allow the server 102 to forego emails and input geographic information, thereby gaining more accurate data in real-time, to bring maximum value to all involved parties.

In embodiments of the server 102, when the hiring manager 202 elects to ping the candidate 208, a drip frequency or tickle feature may be automatically enabled by the system or manually selected or enabled by the hiring manager 202. Under the drip frequency or tickle feature, the server 102 may be set to automatically re-ping the candidate 208 when a reply is not received from the candidate 208 within a predetermined period of time. A frequency of the automatic re-ping may be set by the server 102 or the hiring manager 202. The frequency may be constant or variable. For example, the frequency may decrease overtime, such that the automatic re-pings are eventually no longer sent. The drip frequency or tickle feature may additionally or alternatively be set to expire after a predetermined number of automatic re-pings.

When the hiring manager 202 elects to pass on the candidate 208, the candidate 208 may be removed from a candidate list. The candidate 208 may be discarded entirely, or the candidate 208 may be moved to an alternative location. In embodiments of the server 102, when the hiring manager 202 elects to pass on the candidate 208, the candidate 208 may be prohibited from being a candidate 208 of further searches, or the candidate 208 may be flagged as having been previously passed on. When the hiring manager 202 elects to keep the candidate 208 warm, the candidate 208 is moved to a warm list. The candidate 208 may remain in the warm list for a predetermined period of time or until the candidate is deleted by the hiring manager 202.

FIG. 7 shows a further embodiment of a candidate profile of the candidate 208. In this regard, as shown in FIG. 7, the candidate profile may include an option whereupon the hiring manager 202 may customize an order of a candidate list. The candidate profile may also include a candidate status indication and a candidate verification indication. The candidate status indication may indicate whether a candidate's profile is set to, for example, active, passive, or off-the-grid. As will be described herein, the candidate status may determine a level of accessibility to the candidate's profile. The candidate verification indication may indicate whether any, for example, education and/or certifications have been verified. The verifications may be dependent upon the candidate submitting or otherwise providing any necessary documentation, and/or the verifications may by established independently by the server 102. It should be known and understood that the candidate profile is not limited to the fields of information shown on FIG. 7. The candidate profile may additionally or alternatively include any job credentials, employment history, companies employed by, salaries, achievements, or any other fields of information known and understood.

The candidate profile may additionally or alternatively include an email icon or other indicator which is associated with or otherwise indicates an email address of the candidate 208. The email address may be provided independently of any communication with the candidate 208. That is, the server 102 may obtain the email address of the candidate. The server 102 may obtain the email address by, for example, searching the areas or locations of the network. The candidate profile may additionally or alternatively include further identifying information such as a telephone number, facsimile number, address, social network handle, etc. Accordingly, the hiring manager 202 may be provided with a means for contacting or otherwise initiating communication with the candidate 208.

The candidate profile may further additionally or alternatively include a turbo button or icon which requests the server 102 to contact or otherwise initiate communication with the candidate 208. According to such feature, effort required by the hiring manager 202 may be reduced.

The candidate profile may even further additionally or alternatively include links or icons which are associated with the areas or locations of the network which are searched for identifying the candidate 208. According to such feature, the hiring manager 202 may visit the areas or locations of the network to verify or confirm the information which is being relied upon for identifying the candidate 208.

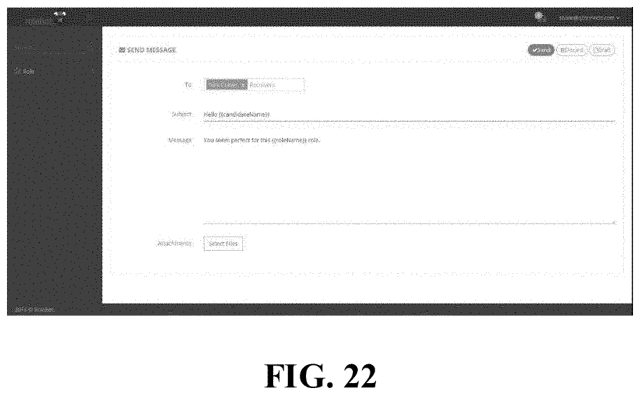

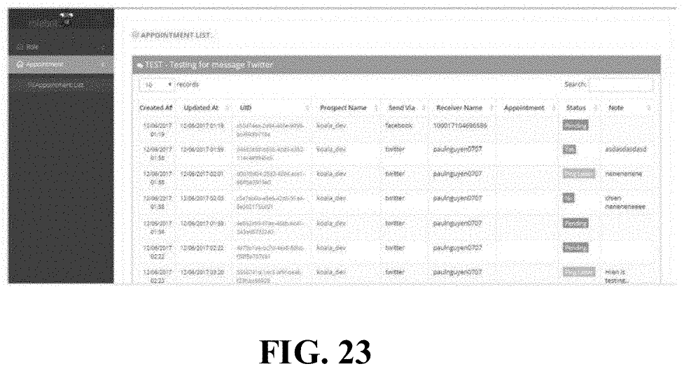

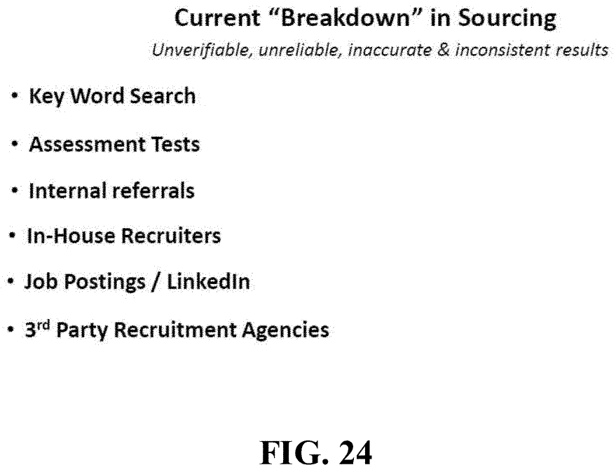

When the hiring manager 202 and one of the candidates 208 express mutual interest, such as when the hiring manager 202 pings the candidate 208 and the candidate 208 replies, the server 102 facilitates establishing an interview between the hiring manager 202 and the candidate 208 via an interview and messaging platform 210 as shown, for example, by FIG. 22. The interview may further be established and monitored via a status dashboard, as shown, for example, by FIG. 23. The server 102 may automatically arrange the interview at a date and time based on calendar information of the hiring manager 202 and the candidate 208. The interview may be arranged as a phone interview, a video interview, an in-person interview, or any additional interview known and understood in the art. When the interview is automatically arranged, personal information of the hiring manager 202 and/or the candidate 208 may be protected. In addition, when such an interview is automatically arranged, the server 102 may negatively affect either of the hiring manager 202 or the candidate 208 which does not show for the interview. For example, when the candidate 208 does not show for the interview, the server 102 may affect the score of interview/review pillar of the candidate 208. Additionally or alternatively, the hiring manager 202 may negatively affect the score of the interview/review pillar of the candidate 208 by leaving a negative review for the candidate 208. When the hiring manager 202 does not show for the interview, the server 102 may fine or otherwise affect a membership status of the hiring manager 202.

In further embodiments, the server 102 may facilitate establishing the interview by providing or offering a benefit to the candidate 208. The benefit may be provided from the server 102 or from the hiring manager 202. The benefit may comprise a monetary or other benefit, and may be set by the server 102 based on member information of the candidate 208 or set by the hiring manager 202 based on a desirability of the candidate. Since the server 102 generally provides reverse recruitment process in which the hiring manager 202 targets the candidate 208, the hiring manager 202 has the ability to entice the candidate 208 to attend the interview.

The candidate profile as shown by FIG. 7 may further include an interview economy concept in which candidates 208 may be allowed to name a price that companies will have to pay to be able to communicate and set up an interview. Such a price would be similar to an access fee for the candidates 208 time and effort. The interview economy concept may be optionally engaged by the candidates. For example, not all candidates 208 would elect to put a price tag on themselves, but some of the more senior level and harder to gain access to skilled professionals may want to put a price tag. Such a price tag would show that the candidates 208 are disciplined and will not jump into an interview process, unless the company is serious. The server 102 may receive a percentage of the price tag, or any additional compensation as generally known and understood in the art such as, but not limited to, a fixed transaction fee.

In any event, upon completion of the interview, at least the hiring manager 202 is given the opportunity to provide feedback 212 for the candidate 208, such that the score of the interview/review pillar of the candidate 208 may be updated. The feedback 212 may be a feedback loop which is optionally provided to both or either of the candidate 208 and the server 102.

Upon receipt of the feedback 212, embodiments of the server 102 may perform analytics 214 of the feedback 212, the interview and messaging platform 210, and selection process of the candidates 208. The analytics 214 may relate to improving the functioning of the server 102. For example, data or scores of the pillars of the candidates 208 may be collected and analyzed to improve the functioning of any algorithms or processes upon which the talent pool 204 is searched. In other words, the analytics 214 may be used to make the algorithms or processes smarter. In this regard, the analytics 214 may additionally or alternatively incorporate the interview and messaging platform 210 and feedback 212 received by the server 102. The feedback 212 may include information from the hiring manager 202 and/or the candidate 208 which attends the interview 210. For example, the algorithms or processes may be updated each time the hiring manager 202 runs a new search or executes the interview and messaging platform 210. The hiring manager 202 may also update his or her profile, or a company profile, for each search. Such a feature would account for constant changes in team dynamics, hiring needs, and any additional requirements.

The analytics 214 may additionally or alternatively relate to a career progression of the candidates 208. That is, if the server 102 has the candidates 208 self-titles through their careers and their years of employment, the server 102 can determine progression as normal versus most. The server may determine the progression as being slow, mediocre, ambitious, complacent to some degree, etc. The analytics 214 may further determine flight risk versus stable risk, medium hiring risk, etc. in view of the career progression. The analytics 214 may further assign a probability or likelihood of leaving or staying at a present or future employment.

In this regard, the analytics 214 may include a lightning feature in which a career progression of a member of the talent pool 206 and/or one of the candidates 208 is analyzed to determine a likelihood of leaving a present position. The lightening feature may require predetermined criteria to be enacted, such as a minimum number of jobs and/or job transitions. The lightening feature may consider both the past and present positions of the member, the lengths of the past and present positions, and other information uncovered in the search of the areas or locations of the network. The lightening feature determines likelihoods of the member leaving the present position during predetermined time frames. If the likelihood of the member leaving the present position during a particular time frame exceeds a predetermined threshold, an indicator may be displayed on the profile of the member.

The indicator may be, for example, a lightening bolt or any other image. Different indicators may be displayed for different time frames and/or different likelihood levels. The predetermined threshold may be the same or different for each time frame. For example, the likelihood level of a member leaving within six months may be required to be larger than the likelihood level of a member leaving within one month such that the hiring manager 202 need not track a large number of potentially leaving members over a long time frame. Of course, the above-example is merely exemplary and the reverse situation may additionally or alternatively be true. That is, the predetermined threshold may be smaller for longer time frames.

In any event, the lightening feature informs the hiring manger 202 about the possibility and potential of the talent pool 206 and/or the candidates 208 leaving their current positions and becoming available. This allows the hiring manager 202 to track desirable candidates such that they may be contacted when they leave their current positions. The server 102 may even provide the hiring manager 202 with notifications when a selected or otherwise uncovered candidate leaves his or her current position, or when the likelihood level of leaving his or her current position exceeds a threshold.

The analytics 214 may additionally or alternatively quantify based on title, e.g., if the candidates 208 are really VP level or senior level. The analytics 214 may further quantify based on principal, .e.g., how hands-on/hands-off the candidates may be. For example, if a one-man shop labels himself as chief technology officer (CTO), but the rest of his credits are developer or systems engineer and they either overlap in years or supplement most of the career, then the server 102 can correlate the candidate has self-titled CTO, but in reality that the self-title is not quantifiable data. As an additional example, some candidates 208 list chief executive officer (CEO) or founder, but the company size is 1-10, or even 1. As a result, the server 102 could reclassify the candidates 208 as principal/individual proprietor versus running a legitimate company or leading a team of more than 2 people. Of course, the above-examples are merely exemplary and are not limiting or exhaustive.

As a derivative of the analytics 214, the server 102 may share such data with companies. For example, the server 102 may share the average amount of time a candidate 208 works for that specific company, or the types of companies that the specific candidate 208 has worked for, or seems to gravitate towards. Such information may be helpful in recruitment targeting, as well as employment brand marketing, advertising, etc.

The analytics 214 may even further tie in salary comparables and can correlate where companies fit in certain competitive pay buckets, which could validate quality of engineering team, or caliber of technology shop reputation. Such information may provide valuable graphs and metrics which may be shown in creative visualizations.

The analytics 214 may be derived by aggregating any combinations of the above-mentioned data and insight, using data science to forecast and come up with predictive analytics for individual candidates and companies within the server 102 or platform. The server 102 or platform may integrate machine learning into any processes or algorithms, which will become smarter on every search, every time.

Upon entry of the feedback 212, the hiring manager 202 and the candidate 208 proceed to the next step 216. The next step 216 may include the exchange of personal information, which may be facilitated by the server 102. Additionally or alternatively, the hiring manager 202 or the candidate 208 may receive personal information of the other via the corresponding member profile information. In this regard, in an embodiment of the server 102, the member profile information of the hiring manager 202 may be private, whereupon the member profile information becomes accessible to the candidate 208 when the hiring manager 202 leaves positive feedback 212 for the candidate 208.

Accordingly, the above-described workflow, examples, and embodiments provide a backwards recruitment process in which employers target the right candidates. The workflow and user interface are simple, the system is easily accessible to human resource departments, recruiters, and hiring managers. The system is also web and mobile friendly. Instead of a person applying for job on a traditional job board, the job generally applies for the person, directly from the company or hiring manager. In other words, the system comprises a reverse job board, mechanically speaking. The system localizes recruitment down to the hiring manager, team, and specific role. The system provides no haggling, targets the right candidates for the role and the team, is based on role requirements and social networking including ranking and/or scoring factors, covers the entire web, is not limited to a single site only, includes ease of use a simplistic user interface, allows for multiple bots at once, provides full control, provides interdepartmental transparency, and provides multiple-user access. Wouldn't candidates rather be sought after by the company or the hiring manager?

The backwards recruitment process of the above-described workflow, examples, and embodiments is based on actionable data, which is data that proves someone is what or who they say they are and not data based just on what that someone says. The candidates 208 are able to be ranked entirely and only on such actionable data. Moreover, the candidates 208 are able to be compared with their peers, based solely on such actionable data. The comparison may be made directly with respect to the peers, e.g., the talent pool 206 or the candidates 208, or made with respect to a community which includes the candidates 208.

The above-described workflow, examples, and embodiments enable business-to-consumer activity. That is, an end user can create a profile and have an updated resume, add any social media profiles—social & professional, list references and past colleagues, list notable projects and major accomplishments, identify hobbies, provide a current geographic location, include code samples, provide a portfolio and tech stack, identify career interests and company types, provide an email address, and provide a current salary/hourly range. The profile may be mobile accessible and set to active, passive, or off-the-grid. As a result, nobody can access it, not even vendors or recruiters. The profile will only be accessed if the end user is right for the role, and shared based on the end user's status. The network is closed, and the end user can add geography, tech stack, company size, basic info on what is wanted. The end user will never be pinged unless role aligns, and the end user has the ability to opt out.

The above-described workflow, examples, and embodiments also enable business-to-business activity. That is, interaction is provided between the server and the hiring manager or employer. The interaction allows for a simple job description, such as the top three skills or responsibilities. The hiring managers and team members are allowed connections across all web channels. Searches may be geography specific to find someone in a specific area or radius. A company blurb may be provided to identify selling points, such as team/hiring manager, background/specific projects, or deliverables. The hiring manager or employer may provide salary info, bonus, and equity if applicable. The hiring manager also includes behind the scenes access, including customizable logins depending on hiring workflows. The hiring manager is also provided full visibility and control, while providing full transparency to human resources.

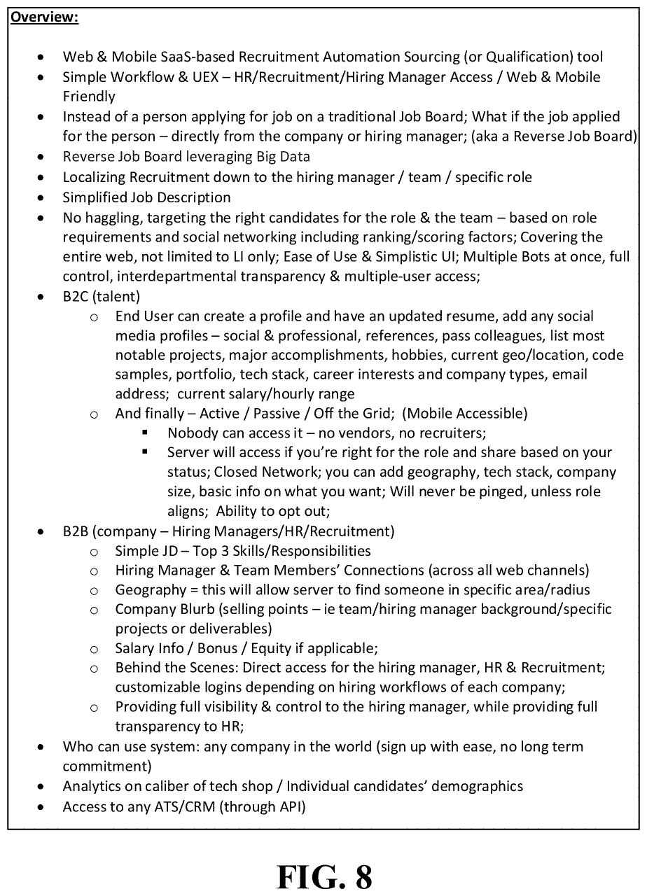

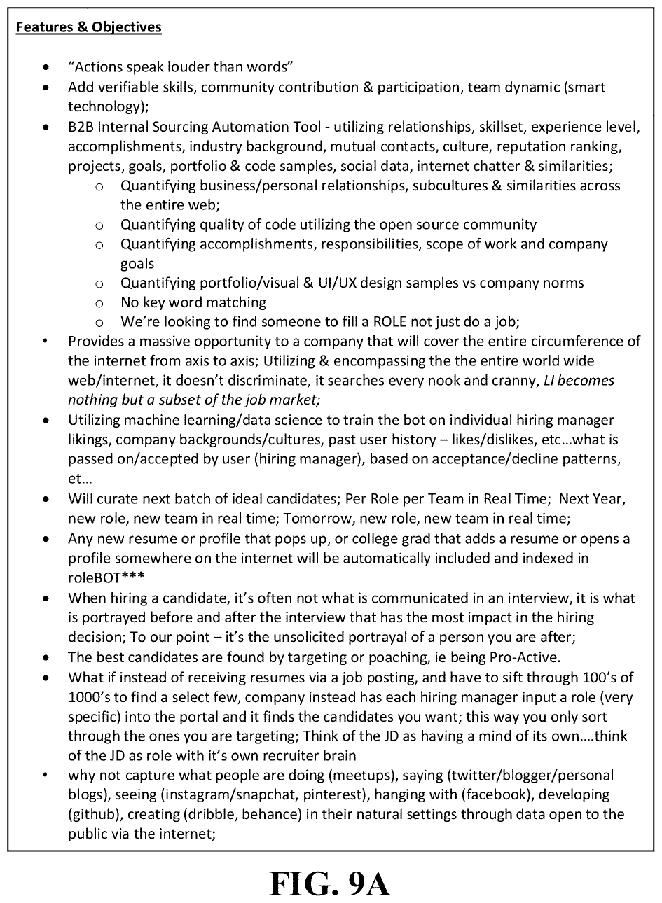

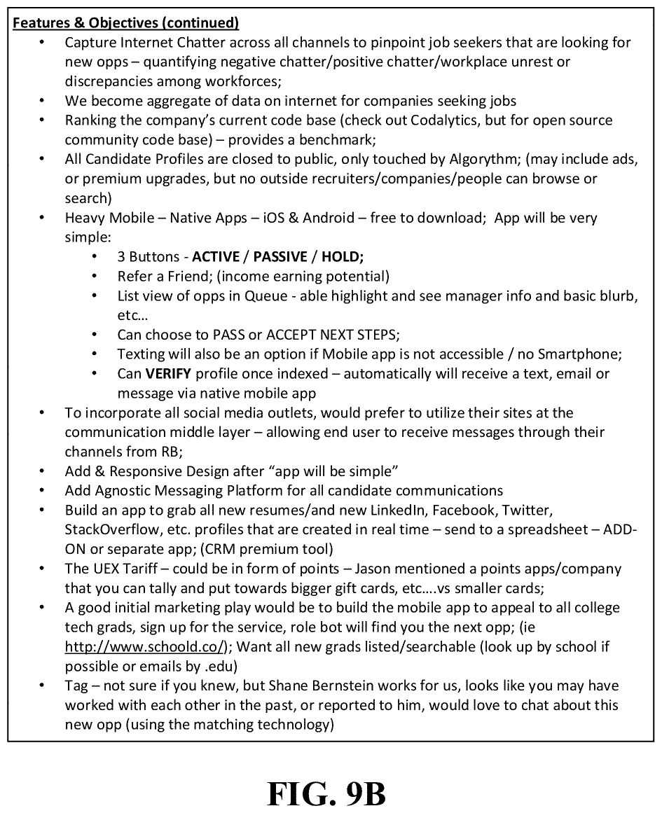

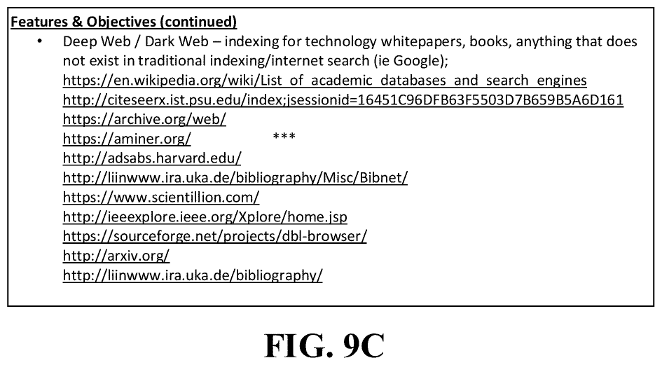

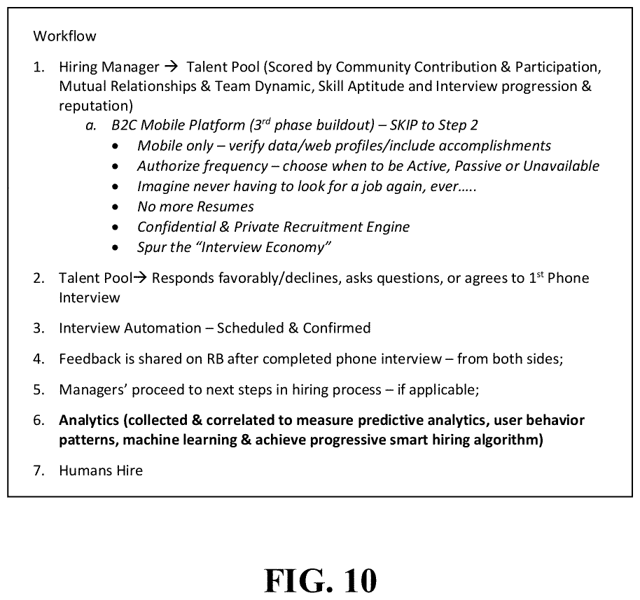

The above-described workflow, examples, embodiments, and effects are merely exemplary and provided for illustrative purposes. The workflow, examples, embodiments, and effects are not to be considered limiting or exhaustive. In this regard, a non-limiting and exemplary list of the effects is provided by FIG. 8. Further, a non-limiting and exemplary list of features and objectives is provided by FIGS. 9A, 9B, and 9C. Even further, a further workflow of an exemplary embodiment is shown by FIG. 10.

The above-described workflow, examples, embodiments, and effects increase workflow speed by providing a number of quality, verifiable candidates. The wait time to locate, review, and interview prospects is significantly reduced, thereby saving time and money as well as reducing anxiety and stress. The recruitment process further coordinates turbulence, minimizes negative results via a limited pipeline, is appropriate for all levels of candidate and hiring manager experience, and is affordable and timely for both candidates and hiring managers.

More specifically, sourcing is the most time consuming and challenging part of recruitment. Up to 50% of time is spent sourcing a candidate, not including speaking/qualifying, setting up interviews, and hiring. If one does not have a trained eye, which many professional recruiters do not, it is very difficult to find the person(s) one is looking for. Instead, most recruitment personnel send every resume w/a matching keyword to a hiring team and let them do the work.

In a job board model, an employer posts a job for which anyone can apply. There are no limits, and it's a free-for-all. Some candidates are qualified, while most are not. In this regard, it is very easy for candidates to hit the send button one thousand times. Once the employer receives these resumes, someone has to go through all of them to determine who are the candidates, are they qualified, and is time available to go further with the candidate.

On the employee side model, also known as false hope, an employee may apply to jobs hours on end, believing there is an end game, only to eventually realize that he or she spent a lot of time submitting with zero results.

On the employer side model, the employer typically does not know how else to go about hiring. The managers are busy doing what they do, the recruiters have 10-100 roles they must fill to meet expectations, and so the employer creates a job description, which is often referred to as “a detailed version of your kitchen sink”, and plasters it on as many job boards as possible with no discrimination. Then, the employer waits, and gets resume after resume after resume. By the time the employer sits down to review the pile of one-hundred-plus resumes, the employer likely has another role to focus on. So, the process is started over. Meanwhile, most of the received resumes go to the “black hole” and, on chance they are right for the role because they saw VP or a specific skillset listed, it doesn't matter anymore, because the resumes are gone. Time is of the essence, and the recruiter is on to the next priority role.

The referral model is a good way to find talent that primarily will be similar to current employed talent. Referral fees are great incentives, but if the people are good, their friends typically are good and working too. While referral fees are great, it takes time to share these opportunities and convince friends to accept, similar to a full-time recruitment job. This is time most internal employees aren't willing to commit to, since they're focusing most of their efforts at their current jobs.

The agency model, or retained/contingent model, is hit or miss as to the external source of candidates depending on the provider. In the agency model, untapped networks of passive candidates, including C-levels, are great to slot into hard to find roles. However, they arrive at a premium, typically mid-senior level talent, as most companies aren't willing to pay someone to find a recent college grad. If the business has a need, and has no other options, this may be a good alternative.

Thus, the above-described workflows, examples, embodiments, and effects improve on the shortcomings of the above-described models.

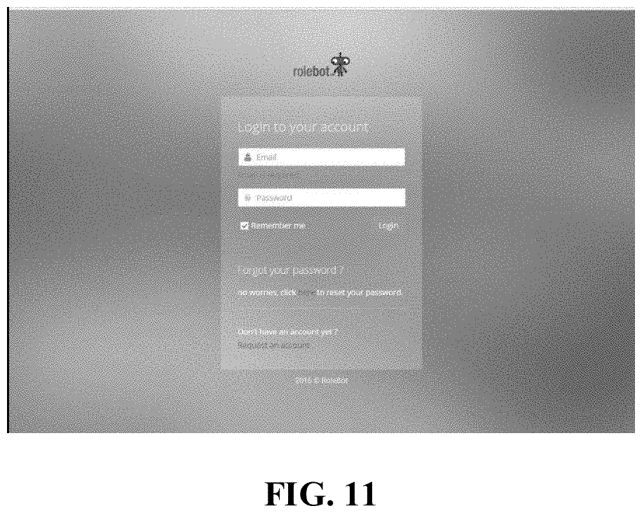

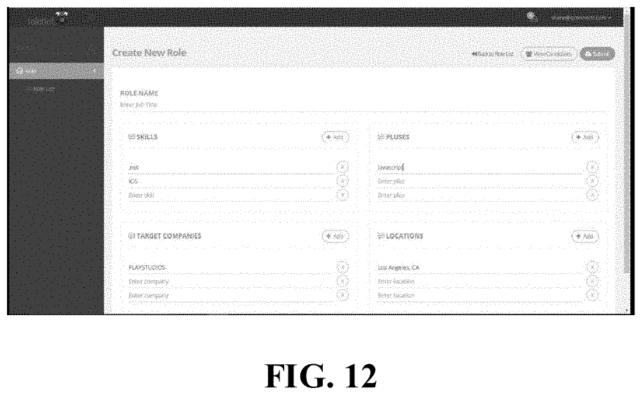

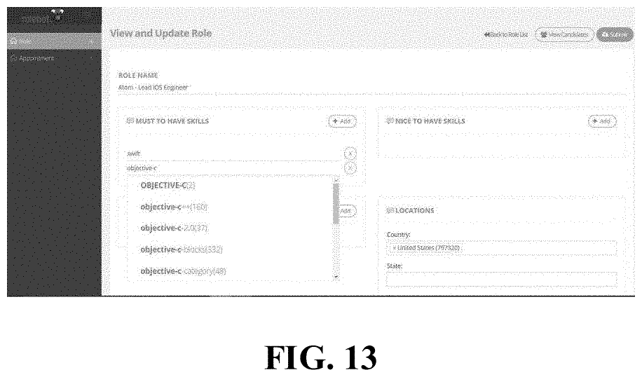

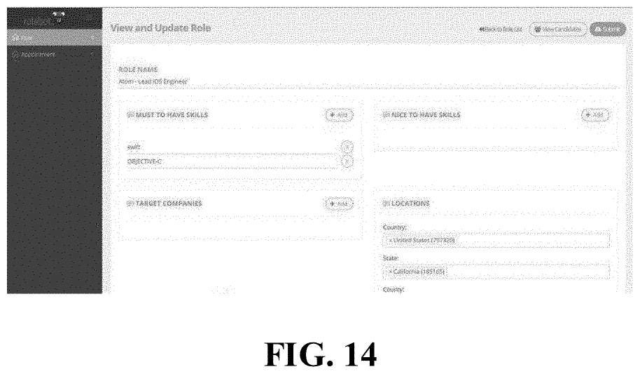

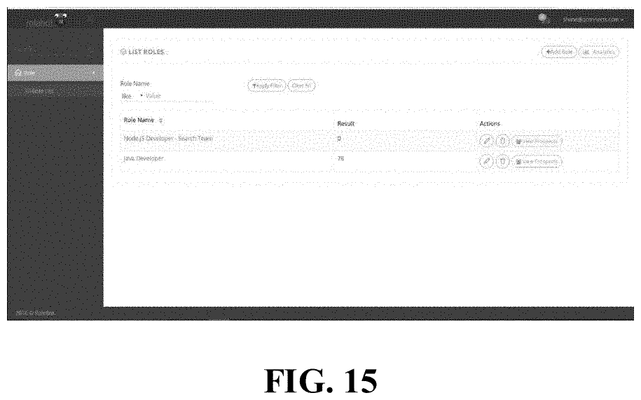

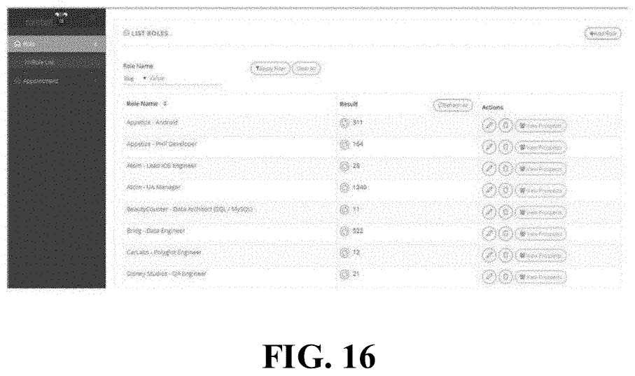

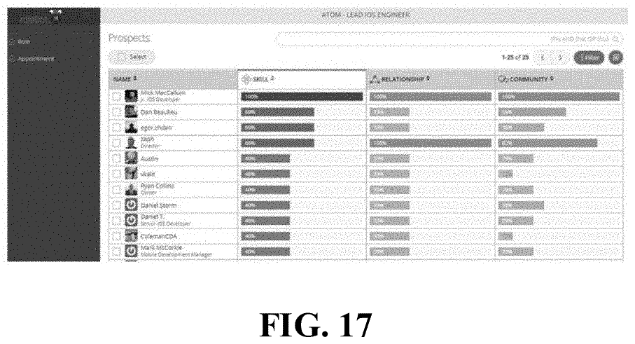

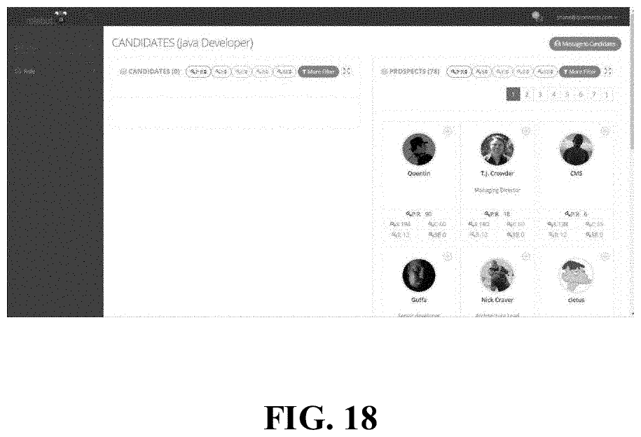

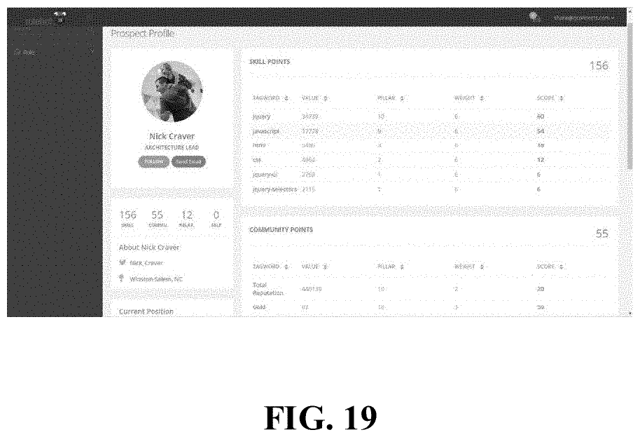

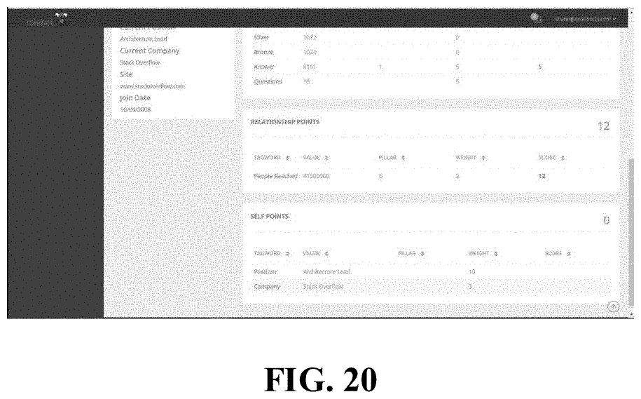

Of course, those skilled in the art appreciate that the present disclosure includes various additional and alternative methods in accordance with the teachings and disclosure set forth herein. Moreover, those of ordinary skill in the art understand the various processes and methods described herein may be implemented by various computer programs and computer-readable media including executable instructions. The computer programs and computer-readable media, when executed, may implement any of the various processes, methods, or combinations thereof disclosed herein. The processes, methods, or combinations thereof may be implemented via various display screens. For example, FIGS. 11, 12, 13, 14, 15, 16, 17, 18, 19, 20, 21, 22, and 23 show various display screens of a program, record on a computer-readable medium.

Accordingly, the present disclosure provides various systems, servers, methods, media, programs, and platforms for sourcing and recruiting candidates into an interview process.

FIG. 26 shows an example schematic of a candidate or prospect search according to an exemplary embodiment of the present disclosure. In the exemplary embodiment, the hiring manger 202 is looking to hire at least one candidate having Skills defined as, for example, S1, S2, S3, R1, C1, and C2. The Skills may be selected by the hiring manager 202. The Skills may be selected via drop-down menus, item-selection lists, or via any other means known and understood in the art. The Skills may additionally or alternatively be input by the hiring manger 202, or the Skills may be stored in association with a profile of the hiring manger 202. The Skills may even further be determined by the server 102. For example, the Skills may be automatically determined by the server 102 based on a position or title selected or otherwise indicated by the hiring manger 202, for which the at least one candidate is sought. The above-described examples are merely exemplary and are not meant to be limiting or exhaustive. The Skills may be determined in accordance with any of the methods or procedures described herein, or in accordance with any additional or alternative means known in the art.

The Skills may be categorized or classified under the pillars described herein. For example, Skills S1, S2, and S3 may be associated with the skill set pillar, Skill R1 may be associated with the relationship pillar, and Skills C1 and C2 may be associated with the community pillar. In this regard, the Skills are described in FIG. 26 as only being associated with three pillars. Nevertheless, it is to be known and understood that the Skills may be associated with less, more, additional, or alternative pillars. For example, among others, the exemplary candidate search may include Skills associated with the self-score pillar.

The Skills may be interpreted as a minimum set of requirements for the at least one candidate, whereas each candidate must qualify for or possess the requirement. Each candidate may be required to merely satisfy the Skill, or to have a certain level or ability with respect to the Skill. In any event, the requisite Skills may be a minimum set of requirements or a mere desired or suggested set of requirements. The Skills, which establish the criteria by which a search for the at least one candidate is conducted, may be modified statically or dynamically to control a number of the at least one candidate as the hiring manager 202 and/or the server 102 sees fit.

Upon input or determination of the Skills, pursuant to which the server 102 conducts a search for the at least one candidate, the server 102 conducts a search of the talent pool 206 as described herein, and as will be described in more detail below regarding FIG. 26.

The server finds or discovers, for example, Filtered Prospect 1 and Filtered Prospect 2. Again, Filtered Prospects 1 and 2 may be found or uncovered in accordance with any of the methods or means described herein. The number of prospects is shown and described as two for convenience. Nevertheless, it is to be known and understood that the number of prospects is not limited to such. The number of prospects which is returned may be uncapped and include all prospects which satisfy the minimum requirements of the Skills, or the number of prospects may be capped in accordance with a criterion or criteria set by the hiring manager 202 and/or the server 102.

The server 102 assigns each of Filtered Prospect 1 and Filtered Prospect 2 a score for each of the Skills. The score may be a numerical score set with respect to or without regards to a range, a ratio, a letter, a percentage, a number of hits, or any other type of score generally known and understood in the art. The scores in FIG. 26 are shown as being ratios representative of a percentage, although such scores are not to be limiting.

Filtered Prospect 1 and Filtered Prospect 2 receive a separate score for each of the Skills. Filtered Prospect 1 and Filtered Prospect 2 may additionally or alternatively receive a score for additional skills which are or are not accounted for in alternative embodiments of the method of FIG. 26. For example, in FIG. 26, a score is shown for Filtered Prospect 2 in regards to Skill S4. Nevertheless, such score is unaccounted for in the search of FIG. 26. The score for the Skill S4 may, however, be provided to the hiring manager 202 as additional information and/or may be used by the server in the machine learning algorithm which will be described below.

The hiring manager 202 may assign an expectation or strength to each of the Skills. The expectation or strength may include generic identifiers such as very strong, strong, neutral, etc. as shown in FIG. 26. In such instance, the method of FIG. 26 translates the generic identifiers into quantifiable identifiers. For example, the method may translate the generic identifiers into ratios or percentages in accordance with a weighting system of the generic identifiers. That is, each of the generic identifiers may be assigned a value, such as two for very strong, one for medium, zero for neutral, etc. Thereafter, the method determines a ratio or percentage of each skill to the whole. The ratio or percentage of each skill may be relative to the pillar or category within which the skill is associated, such as the skill set pillar, the relationship pillar, and the community pillar. Additionally or alternatively, the ratio or percentage of each skill may be relative to the Skills as a whole. In this regard, Skills may be weighted in accordance with any additional and/or alternative techniques known and understood in the art. The Skills may even be weighted by including a filter mechanism which removes, discounts, or otherwise negates outlying values of the Skills.

While the Skills are shown as including generic identifiers, e.g., weights, in FIG. 26, it should be known and understood that the Skills may include additional weights which are assigned by the hiring manager 202 or the server 102. For example, the Skills may be ranked in order of priority or assigned numerical weights. The server 102 may then translate such priority order or numerical weights into the ratios or percentages shown by FIG. 26 and/or described above. Of course, the hiring manager 202 may assign the ratios or percentages for the Skills as an alternative to the server 102 determining the ratios or percentages. The hiring manager 202 may assign the ratios or percentages in addition to, or as an alternative to, assigning the representative identifiers, such as very strong, strong, neutral, etc. In any event, the ultimate ratios or percentages of the respective Skills may be determined in accordance with any of the above-described methods, and/or in accordance with any additional or alternative methods understood in the art.

The ratios or percentages are respectively applied to the scores of the Skills to determine a single score for each pillar or skill category. For example, as shown in FIG. 26, the ratio of 2/4 is applied to S1 while the ratio of 1/4 is applied to each of S2 and S3. The same ratios or percentages are respectively applied to the scores of the Skills of each of Filtered Prospect 1 and Filtered Prospect 2 to determine overall scores for the categories or pillars, as shown in FIG. 26. However, in alternative embodiments, different ratios or percentages may be applied to the scores of the Skills of Filtered Prospect 1 and Filtered Prospect 2 to determine the overall scores for the categories or pillars. For example, if one of Filtered Prospect 1 and Filtered Prospect 2 includes a predetermined skill, or if the search of for the at least one candidate uncovers a certain trait or characteristic within one of the Skills of one of Filtered Prospect 1 and Filtered Prospect 2, such Skill may be adjusted to have a higher or lower ratio or percentage. Also, if the score for one of the Skills exceeds or is below a certain threshold score, such Skill may be adjusted to have a higher or lower ratio or percentage. The threshold score may be fixed and/or predetermined, or the threshold score may be set relative to the other Skills within the same category or pillar. In other words, if one Skill in a category or pillar differs from the other Skills in the category or pillar by a predetermined or relative amount, e.g., if the one Skill is an outlier, the ratio or percentage with which the one Skill is weighted may be increased or decreased.

Accordingly, the ratios or percentages are applied to the Skills within each category or pillar to determine an overall score for each category or pillar. The ratios or percentages may be applied individually or universally to the categories or pillars in accordance with any of the methods described above, or in accordance with any additional methods which are known and understood in the art. In any event, an overall score is determined for each category or pillar as shown FIG. 26.

Thereafter, an overall weighting is applied to the overall score of each of the categories to determine a single score for each of Filtered Prospect 1 and Filtered Prospect 1. The overall weighting which is to be applied to the overall score of each of the categories may be set in accordance with a bias of the hiring manager 202, or the overall weighting may be set by the server 102. The overall weighting may be set or applied in accordance with any of the above-discussed embodiments relating to the category or pillar weightings, or in accordance any additional known and understood methods. In any event, a single, final score is determined for each of Filtered Prospect 1 and Filtered Prospect 2. For example, the final score of Filtered Prospect 1 may be determined in accordance with the following equation:

1/2[2/4(30/100)+1/4(80/100)+1/4(09/100)]+1/4[1/1(90/100/]+1/4[2/3(34/100)+1/3(34/100)]=49.6%

Of course, the above-values and method of determining the single, final score are merely exemplary and are not limiting.

Upon determination, the server 102 outputs the single, total score for each of Prospect 1 and Filtered Prospect 2. The server 102 may make a recommendation based on the total score alone, or based on the total score in connection with additional criteria. An example of the additional criteria by which the server 102 may make the recommendation will be described below.

The hiring manager 202 receives the single, total score for each of Filtered Prospect 1 and Filtered Prospect 2, and may proceed in accordance with any suitable manner. For example, the hiring manager 202 may choose a recommended one of Filtered Prospect 1 and Filtered Prospect 2, or the hiring manager 202 may choose a non-recommended one of Filtered Prospect 1 and Filtered Prospect 2. The hiring manger 202 may also be presented with an option for viewing or reviewing additional or alternative prospects by the same or additional criteria. For example, should the hiring manager 202 wish to expand or narrow the search, the hiring manager 202 may modify the Skills based upon which the search is conducted. As an additional example, should the hiring manager wish to modify the weights of the Skills and/or the categories or pillars, the hiring manager 202 may modify the ratios or percentages assigned thereto and be presented with an updated single, total score for each of Filtered Prospect 1 and Filtered Prospect 2 and/or additional prospects.

Upon satisfaction of the search and results, the hiring manager 202 may accept, exclude, or otherwise select each or any of Filtered Prospect 1 and Filtered Prospect 2. For example, the hiring manager 202 may proceed with the interview process for Filtered Prospect 1 and/or Filtered Prospect 2, exclude Filtered Prospect 1 and/or Filtered Prospect 2 from any future searches, or archive Filtered Prospect 1 and/or Filtered Prospect 2 for later searches. Again, these examples are merely exemplary and are not limiting or exhaustive. The hiring manager 202 may use the results of the search in accordance with any additional or alternative known methods.

In the embodiment shown by FIG. 26, the method may further include a learning process or algorithm. In such embodiment, a selected candidates database may include a list of candidates. The list of candidates may include any candidates which were previously uncovered, or the list of candidates may be limited to select candidates based on predetermined criteria. For example, the list of candidates may be limited based on candidates having certain Skills or candidates having certain scores or ratios amongst one or more of the Skills. The list of candidates may additionally or alternatively be limited to candidates having certain single scores for each pillar or skill category. In this regard, the certain scores across the Skills of the pillar or skill category may be determined by exceeding a threshold or by being in a predetermined percent relative to other candidates, such as by being in the top ten percent. Candidates which include a single score for a skill and/or a pillar or skill category which satisfies the criteria may be selected, or the candidates may be required to satisfy the criteria across a predetermined number or all of the Skills and/or the pillars or skill categories.

Additionally or alternatively to being limited by the scores for the Skills or the scores for each pillar or skill category, the list of candidates may be limited by the total score determined for each candidate, such as the total score for each of Filtered Prospect 1 and Filtered Prospect 2. In this regard, the total score may be static or dynamic. That is, the total score for each of Filtered Prospect 1 and Filtered Prospect 2 as described above may be stored in association with the prospects in the selected candidates database. Additionally or alternatively, scores for the individual Skills may be stored in association with the prospects in the selected candidates database. As a result, for each new search, a new total score may be computed for each of the stored candidates based on the input criteria of the hiring manager 202, such as the Skills selected by the hiring manager 202 and the weightings assigned thereto.

In even further embodiments, the selected candidates database may include candidates which were previously accepted, selected, or otherwise indicated by the hiring manager 202 and/or the server 102. In this regard, the selected candidates database may include previously successfully hired candidates. The hired candidates may be included upon being hired, or included after a predetermined grace period and/or when reported by the employers as being successful. The selected candidates database may even further include employees of employers or other exemplary individuals which are selected for the sole purpose as being exemplary candidates. The candidates included in the selected candidate database may be independently determined by the server 102 and/or provided by the hiring manager 202 as a point of reference.

In any event the selected candidates database includes a list of reference candidates that may be determined in accordance with any of the above described methods, or combinations thereof, and also in accordance with any alternative or additional methods which may be known and understood in the art.

The server 102 may compare the scores of the Skills, the scores of the pillars or skill categories, and/or the total scores of each of Filtered Prospect 1 and Filtered Prospect 2 with like scores of the reference candidates stored in the selected candidates database. The server 102 may compare each of Filtered Prospect 1 and Filtered Prospect 2 with all reference candidates or any subset thereof. For example, the server 102 may compare each of Filtered Prospect 1 and Filtered Prospect 2 with only those reference candidates which have scores for the Skills which are selected by the hiring manager 202, for which the search is conducted. The server 102 may additionally or alternatively compare each of Filtered Prospect 1 and Filtered Prospect 2 with only those reference candidates who have score(s) for particular Skill(s) which are selected by the hiring manager 202 and/or the server 102. The server may even further additionally or alternatively compare each of Filtered Prospect 1 and Filtered Prospect 2 with only those reference candidates who have similar score(s) for particular Skill(s) which are selected by the hiring manager 202 and/or the server 102. In even further embodiments, the subset of the reference candidates with which Filtered Prospect 1 and Filtered Prospect 2 are compared may be determined in accordance with any known and understood methods.

Filtered Prospect 1 and Filtered Prospect 2 are compared with the reference candidates, or a subset thereof, which may or may not include previously successful hires, to determine a closeness or similarity of Filtered Prospect 1 and Filtered Prospect 2 with the selected reference candidates. The closeness or similarity may be determined based on the scores of the Skills, the scores of the pillars or categories of skills, and/or the total scores in a vector space to determine a numerical value representative of the closeness or similarity on a predetermined scale. The numerical value representative of the closeness or similarity may be used by the server 102 to provide a recommendation of one of Filtered Prospect 1 and Filtered Prospect 2. The numerical value representative of the closeness or similarity may be used by the server 102 to provide the recommendation discussed above, or the numerical value representative of the closeness or similarity may be used by the server 102 to provide a confirmation of the recommendation discussed above. The numerical value representative of the closeness or similarity may or may not be presented to the hiring manager 202 such that the hiring manager 202 may or may not base his or her acceptance of any of Filtered Prospect 1 and Filtered Prospect 2 based on such closeness or similarity. For example, in an exemplary embodiment, the hiring manager may provide one or more employees or otherwise desirable or acceptable candidates as the reference candidates. Thereafter, the hiring manager 202 may accept any of Filtered Prospect 1 and Filtered Prospect 2 based on a similarity with the desirable or otherwise acceptable reference candidates. Of course, such example is merely exemplary and is not meant to be limiting.

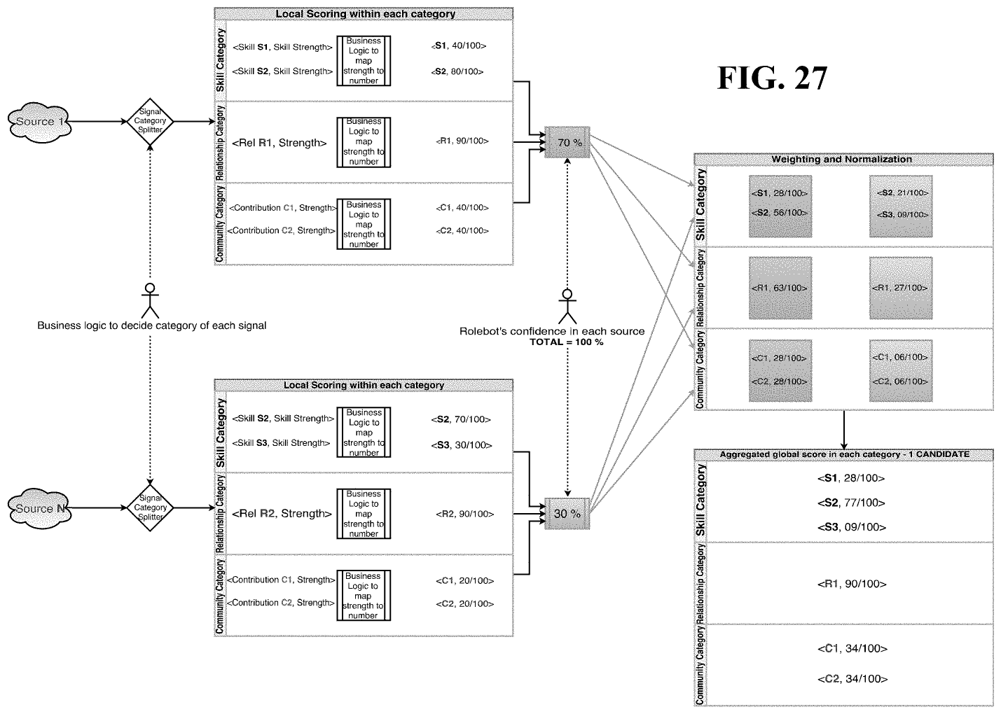

FIG. 27 shows an exemplary schematic of an individual prospect or candidate search according to an exemplary embodiment of the present disclosure. In the exemplary embodiment, the search may be conducted pursuant to the above-mentioned Skills, e.g., S1, S2, S3, R1, C1, and C2, of FIG. 26. As described above, the Skills may be determined by the hiring manager 202, the server 102, or in accordance with any of the additional or alternative methods described herein.

The individual prospect or candidate may result in, e.g., Filtered Prospect 1 or Filtered Prospect 2. In this regard, a plurality of sources, e.g., Source 1 and Source 2, may be searched for candidates having the Skills. The searches may be conducted on websites or any additional sources as described herein. The individual prospect or candidate may be identified at one of the sources, whereupon additional sources are searched for the identified candidate. Additionally or alternatively, plural sources may be searched for a candidate in common.

In any event, for a single prospect or candidate, the plurality of sources is searched to determine scores for each of the Skills. A local score for each of the Skills may be determined for each of the sources. The local score may be determined based on the content of each source, using business logic to map the content to the local score. The business logic may be the same or different for each of the sources, and the same or different for each of the Skills within the sources. The business logic may be based on or include any of the features described herein, with the business logic mapping the content of the website to a score for each of the Skills.

In the embodiment shown in FIG. 27, the server 102 assigns each of the sources a confidence score. The confidence score may be a ratio, a percentage, or any other value described herein. The confidence score may be assigned by the server 102 as shown in FIG. 27, or the confidence score may be assigned by the hiring manager 202 in additional or alternative embodiments. In even further embodiments, the sources may not be associated with confidence scores. The confidence scores are generally assigned based on the trustworthiness or reliability of the content therein. The confidence scores may be universally applied to each of the Skills within a source, or different confidence may be applied for different Skills or pillars or categories of Skills. For example, a particular source may be trustworthy with respect to a certain Skill or pillar, but not as trustworthy with respect to another Skill or pillar.

The confidence scores are applied to the Skills for each of the sources to weight and normalize the scores for each of the Skills. For example, as shown in FIG. 27, Source 1 may have a score of 80/100 for Skill S2 and a confidence of 70%, while Source 2 may have a score of 70/100 for Skill S2 and a confidence of 30%. The resultant weighted and normalized values for the Skill S2 of Source 1 and Source 2 are 56/100 and 21/100, respectively. Of course, the above-described example is merely exemplary and not limiting or exhaustive. The scores for the Skills across the Sources may be weighted and normalized in accordance with any additional or alternative methods which are known in the art.

The weighted and normalized scores for the Skills across the Sources are aggregated to determine a total score for each Skill for the individual prospect or candidate. For example, with respect to the above-described example and as shown in FIG. 27, the weighted and normalized values for the Skill S2 of Source 1 and Source 2 of 56/100 and 21/100 are aggregated to arrive at a total score of 77/100. Again, this example is merely exemplary and not limiting or exhaustive. The aggregated scores thus arrived at for the individual prospect or candidate may then be compared with other prospects or candidates, as described with respect to FIG. 26.

Accordingly, all relevant information associated with a prospect or candidate may be pulled from various sources over the Internet. Each source adds some employment value which may quantify and explain the candidate's quality or value. Each input from each source may be a signal. Each signal is evaluated for association with, for example, one of the evaluation categories: Skill, Relationship, and Community. Business Logic is used to map the strength of each signal to a number. So, finally the system arrives at tags and their number relative on a predetermined scale, e.g., from 0-100, for each source. Based on the systems' confidence and logic from each source, a relative weight is assigned to the source, such that total number of source weights equals 100. This information is used to weigh and normalize previously mapped numbers of tags. Finally, all tags are placed together in respective categories. If any duplicate skill coming from different sources is found, it may be aggregated at this level. The end result is a set of tags and their weights being placed in set categories.

According to such features, a hiring manager may use the platform to hire candidates with technical skills, good network, and contributions to the community.

The system quantifies the above information and then filters among candidates to list filtered prospects that match set requirements. For example, for simplification purposes, assume two candidates are shortlisted as prospects. The system maps specifications of the hiring manager 202 to the shortlisted candidates and assigns each prospect a percentage in each of the pillars of evaluation, such as Skill, Relationship, and Community. These three percentages may be again combined into one number based on a bias of the hiring manager 202 to each of the pillars. Candidates are sorted and presented as result. The system thereafter compares all prospects matching requirements of the hiring manager with historical data of successful hires for similar roles. All prospects are then ranked based on their similarity with successful ones. The result is integrated with the previously mentioned statistical solution. Finally, the hiring manager 202 has the flexibility to choose any of the recommendations or pick his or her own.

A further embodiment of the present disclosure is provided in which features of the present disclosure are provided in a widget. While the term widget is used, it should be known and understood that the further embodiment may be embodied in any additional or alternative icon, link, application, program, macro, or other known computing element. The widget may include any combination of the features described herein, such as in the following example.

The widget may be associated with a particular location or area of the network, or the widget may be associated with the hiring manager 202. For example, in embodiments in which the widget is associated with the particular location or area of the network, the particular location or area of the network may be a webpage and the widget may be a web widget or web application that is embedded as an element of the webpage. In embodiments in which the widget is associated with the hiring manager 202, the widget may comprise a browser extension. In any event, the widget provides an interface between a location or area of the network and the server 102.

The widget, whether associated with the particular location or area of the network or the hiring manager 202, may further be associated with a particular candidate 208. For example, the widget may be embedded within the particular location or area of the network in association with the particular candidate 208, or the browser of the hiring manager 202 may be showing a webpage associated with the particular candidate 208. Additionally or alternatively, the particular candidate may be selected in combination with or by means of the widget.

Upon selection or execution of the widget by the hiring manger 202, either via the element embedded within the particular location or area of the network or via the browser extension, a request for contacting or otherwise communication with the particular candidate 208 is initiated. The request is transmitted or otherwise communicated to the server 102 along with information of the particular candidate 208. The information of the particular candidate 208 may include a name, a username, a handle, and/or any other identifying information of the particular candidate 208. The request may further be transmitted or otherwise communicated to the server 102 along with information of the hiring manager 202. The information of the hiring manager 202 may include a name, username, identification number, and/or any other identifying information of the hiring manager 202.

The server 102, based on the information of the particular candidate 208 and the information of the hiring manager 202, initiates communication with the particular candidate 208 on behalf of the hiring manager 202. The communication may be initiated to arrange, for example, an interview between the particular candidate 208 and the hiring manager 202.

Accordingly, the hiring manager 202 is able to arrange for communication with the particular candidate 208 via the server 102. In other words, the hiring manager 202 merely has to observe or notice the particular candidate 208 at a particular location or area of the network, select or execute the widget, and await arrangement of the communication, such as the interview, by the server 102

In an alternative embodiment of the above-described example, the information of the particular candidate 208 which is provided to the server 102 upon selection or execution of the widget by the hiring manger 202, may not include information which is sufficient for contacting the particular candidate 208. For example, the widget may pull, scrape, or otherwise retrieve identification information of the particular candidate 208 from the webpage on which the candidate is listed. However, the identification information may not include contact information of the particular candidate 208. In this regard, the server 102 may search the talent pool 206, which may be previously stored in its database or derived by searching the locations or areas of the network, based on the identification information to find the particular candidate 208 therein. The server 102 may then use information derived by searching for the talent pool 206 to obtain the contact information of the particular candidate 208. Thereafter, the server 102 may initiate the communication with the particular candidate 208 on behalf of the hiring manager 202 using the obtained contact information. Thus, according to such embodiment, the hiring manager 202 may arrange for communication with the particular candidate 208 by visiting, for example, a webpage and selecting or executing the widget when the contact information of the particular candidate 208 is not readily available on the webpage.

In a further alternative embodiment of the above-described example, the widget may be selected or executed by the hiring manager in order to search a particular location or area of the network for candidates 208. For example, in an embodiment in which the widget is a browser extension, the hiring manager 202 may visit a particular webpage or domain. The hiring manger 202 may select or otherwise execute to the widget to determine whether any candidates 208 exist within the users or members of the website or domain. In other words, the users or members of the website or domain may comprise the talent pool 206 from which the candidates 208 are searched. The talent pool 206 may be searched in accordance with any of the methods or embodiments described herein. Thus, according to such embodiment, the hiring manager 202 may search a particular location or area of a network which may of interest to the hiring manager 202 for candidates 208.

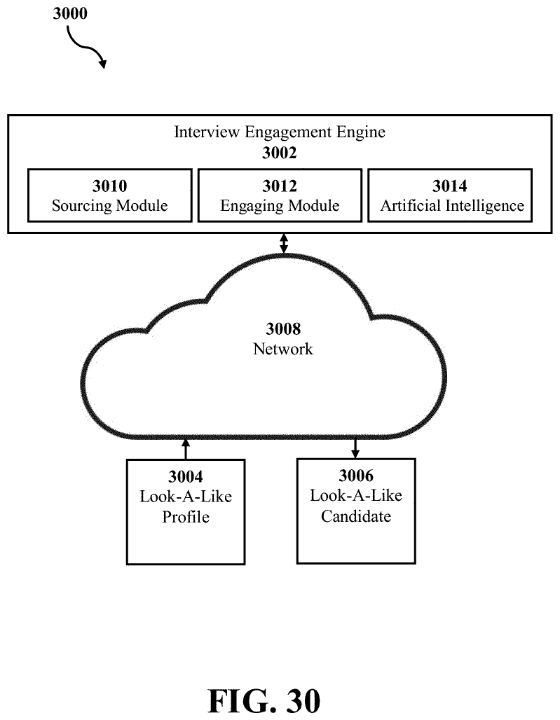

A further embodiment of the present disclosure is provided as a system 3000 for sourcing and recruiting look-a-like candidates. The system 3000 is generally shown in FIG. 30, although it should be known and understood that the system 3000 may comprise, be included within, or be implemented by any of the embodiments described included herein such as, for example, any of the servers, systems, programs, methods, media, devices, etc. For example, the system 3000 may be implemented by various configurations of the server 102 as described with respect to FIG. 1. Of course, the system 3000 may also be implemented in accordance various methods, and also may comprise various computer programs and computer-readable media including executable instructions. The computer programs and computer-readable media, when executed, may implement any combination of the following features, processes, and methods of the system 3000. Further and for convenience, the system 3000 will hereinafter be described as a Look-A-Like System 3000.

The Look-A-Like System 3000 includes an Interview Engagement Engine 3002. Such Interview Engagement Engine 3002 may additionally or alternatively comprise any of the hardware, software, or other components described herein in further embodiments of the present application, including the various components and configurations of the server 102 as described with respect to FIG. 1.

The Interview Engagement Engine 3002 may provide, among other features, a click-to-interview-to-hire functionality. That is, the Interview Engagement Engine 3002 may allow the hiring manager 202 to establish an interview, or multiple interviews, via a single “click” or request. Hereinafter the Interview Engagement Engine 3002 will be described as establishing a single interview for convenience. Nevertheless, it is to be known and understood that plural interviews, with a single one of the candidates 208 or with multiple candidates 208, may be established as well. As will be described in more detail below, the Interview Engagement Engine 3002 determines at least look-a-like profile 3004 that corresponds to an individual for whom the hiring manager 202 desires to interview a look-a-like candidate 3006. In other words, the Interview Engagement Engine 3002 determines the look-a-like profile 3004 such that a look-a-like candidate 3006 that mirrors the desirable individual may be interviewed.

The Interview Engagement Engine 3002 may receive the look-a-like profile 3004, or any information upon which the look-a-like profile 3004 is determined or created, from the hiring manager 202 and inform the hiring manager 202 of the look-a-like candidate 3006 and/or arrange the interview between the hiring manager 202 and the look-a-like candidate 3006 via at least one network 3008. The at least one network 3008 may include any single one or combination of the networks described herein, including the network 122 of FIG. 1. The Interview Engagement Engine 3002 searches an area or location of the at least one network 3008 in accordance with any of the embodiments described herein to find the look-a-like candidate 3006 based on the look-a-like profile 3004, and may engage the look-a-like candidate 3006 to establish the interview, either with the hiring manager 202, the Interview Engagement Engine 3002, or any representative of either via the at least one network 3008.

In an exemplary embodiment, the Interview Engagement Engine 3002 may comprise a Sourcing Module 3010 and an Engaging Module 3012. Each of the Sourcing Module 3010 and the Engaging Module 3012 may also be the same as, similar to, or be included within the server 102. The Sourcing Module 3010 and the Engaging Module 3012 may each additionally or alternatively comprise any of the hardware, software, or other components described herein in further embodiments of the present application. The Sourcing Module 3010 is generally responsible for sourcing or finding the look-a-like candidate 3006 based on the look-a-like profile 3004, while the Engaging Module 3012 generally engages the look-a-like candidate 3006 to establish the interview.

The Sourcing Module 3010 may receive and develop a look-a-like talent pool. That is, the Sourcing Module 3010 receives, determines, or otherwise creates the look-a-like profile 3004. In this regard, in embodiments of the present disclosure, the Sourcing Module 3010 may receive, determine, or otherwise create a look-a-like profile 3004 based on a single individual. However, in additional or alternative embodiments, the Sourcing Module 3010 may receive, determine, or otherwise create the look-a-like profile 3004 based on plural individuals. It should be known and understood that the terms “individual” and “individuals” may be used interchangeably herein. Furthermore, while it is generally described above that the look-a-like profile 3004 is generated based on the individual, or characteristics thereof, the look-a-like profile 3004 may comprise a profile of the individual. In other words, the look-a-like profile 3004 may be the profile of the individual, or look-a-like profiles 3004 may comprise profiles of individuals.

The look-a-like profile 3004 may be received from the hiring manager 202 and correspond to an individual for whom the hiring manager 202 desires to hire and/or interview as the look-a-like candidate 3006. Again, while the singular form of “look-a-like candidate” is used, the phrase “look-a-like candidates” may be used interchangeably throughout the present disclosure.

The look-a-like profile 3004 may comprise an actual profile of a real individual, or the look-a-like profile 3004 may be created from characteristics of or the actual profile of the real individual. The characteristics of the individual from which the look-a-like profile 3004 may be created may include any of the characteristics described herein, including those related to the pillars. The characteristics may additionally or alternatively include any characteristics which are known and understood in the art.

The look-a-like profile 3004 may be created from or include, for example, an electronic or online profile of the real individual. The electronic or online profile may be a web profile, or any other profile associated generally or specifically with any user, website, network, application, or other electronic environment. The look-a-like profile 3004 may be created from, associated with, or correspond to a specific uniform resource locator (URL), or the look-a-like profile 3004 may be created from, associated with, or correspond to a username, handle, character, or other identifying information. For example, in an exemplary embodiment, the look-a-like profile 3004 may be created from or include a LinkedIn profile and/or a corresponding URL of the LinkedIn® profile. Of course, the above-described examples are merely exemplary and are not limiting or exhaustive. In additional embodiments of the present disclosure, the look-a-like profile 3004 may be provided in additional or alternative manners which are generally known and understood in the art without departing from the scope of the present disclosure.

As discussed above, the look-a-like profile 3004 may be of or correspond to a real individual. For example, the hiring manager 202 may select an actual profile of an exemplary or exceptional employee or other individual, or the hiring manager 202 may provide a profile of himself or herself to which the look-a-like profile 3004 is to correspond. Further, should the hiring manager 202 be required to replace an otherwise satisfactory employee or other individual, the hiring manager 202 may select the profile of such individual to which the look-a-like profile 3004 is to correspond. Alternatively, the look-a-like profile 3004 may relate to a fictitious individual from which the hiring manager composites or otherwise creates such profile. Of course, these examples are merely exemplary and the look-a-like profile 3004 may be specified or otherwise created in accordance with any known and understood methods, or based on any real or fictitious persons. The look-a-like profile 3004 may even relate to characters in literary or other theatrical works, or based on historical people and/or leaders of certain industries.

The look-a-like profile 3004 may correspond to a complete profile that is provided by the hiring manager 202 and received by the Sourcing Module 3010. Additionally or alternatively, the hiring manager 202 may merely provide a name or other identifying information from which such look-a-like profile 3004 is to be created. The identifying information may comprise a name, a username, a handle, or any additional or alternative identifying means described herein. In such case where the name or other identifying means is provided to the Sourcing Module 3010, the Sourcing Module 3010 may construct a “digital persona” of the individual. The “digital persona” may be created using any of the areas or locations of the at least one network 3008 as described herein, including any predefined or otherwise selected portions. Further, the “digital person” may be created using any data contained within the areas or location of the at least one network 3008, including being limited to the actionable data as described herein. In other words, the “digital persona” may be created in accordance with any manner in which the talent pool 206 is searched and returned, although while being limited to the name or other identifying means associated with the “digital persona.” Of course, the “digital persona” may comprise or be limited by any of the information disclosed herein, as it relates to searching the talent pool 206 or otherwise. Accordingly, the Sourcing Module 3010 creates the “digital persona” or other electronic or online profile of the individual specified by the hiring manager 202 from which the look-a-like profile 3004 is created, such that the look-a-like profile 3004 may be derived from the areas or locations of the at least one network 3008 or talent pool 206.

In embodiments of the present application, the hiring manager 202 may provide plural profiles, or specify plural individuals upon which the “digital persona” or the look-a-like profile 3004 is to be created. Of course, the hiring manager 202 may further provide plural identifying means, or any combination of profiles, individuals, or identifying means. In any event, in such embodiments, the Sourcing Module 3010 may generate or construct a look-a-like profile 3004 from plural individuals or “digital personas” from which the look-a-like candidate 3006 is to be sourced. The Sourcing Module 3010 may additionally or alternatively create plural look-a-like profiles 3004 from which the look-a-like candidate 3006 is to be sourced. The plural look-a-like profiles 3004 may be constructed in same or different manners, in accordance with any of the disclosure set forth herein. In fact, in embodiments of the present application, plural look-a-like profiles 3004 may be constructed from a single profile, individual, or identification means provided by the hiring manager 202. In such embodiments, the plural look-a-like profiles 3004 may be constructed in accordance with different methods disclosed herein.

In the embodiments in which the Sourcing Module 3010 constructs plural look-a-like profiles 3004 or otherwise receives identifying information of plural individuals, the look-a-like candidate 3006 may be identified by being the same or similar to any or all of the look-a-like profiles 3004 and/or the same or similar to any or all of the plural individuals. The look-a-like candidate 3006 may receive a closeness or similarity score or ranking as generally described herein, and may be determined to be sufficiently similar to the look-a-like profiles 3004 and/or plural individuals by being within or exceeding a predetermined score or ranking. The predetermined score or ranking may be set by the hiring manger 202 or the Interview Engagement Engine 3002. Of course, the look-a-like candidate 3006 may be determined in accordance with additional or alternative means, such as by being more similar or close to the look-a-like profiles 3004 and/or plural individuals than the other candidates 208, and/or by being sufficiently similar to any one of the look-a-like profiles 3004 and/or plural individuals. Of course, the look-a-like candidate may be determined in accordance with any additional or alternative means as set forth herein, or in accordance with any additional or alternative methods which are generally known and understood in the art.

In further embodiments of the present application other than those in which the look-a-like candidate 3006 is determined based on the look-a-like profiles 3004 and/or individuals individually, the look-a-like candidate 3006 may be determined based on the look-a-like profiles 3004 and/or individuals in combination. For example, the look-a-like profiles 3004 and/or characteristics of the individuals may be combined to determine at least one hybrid profile upon which the look-a-like candidate 3006 is to be selected. The look-a-like profiles 3004 and/or characteristics of the individuals may be combined by averaging, by selecting common items of information, or by selecting any items of information occurring in any of the profiles. The look-a-like profiles 3004 and/or characteristics of the individuals may even further be combined by selecting certain features or items of information from each of the look-a-like profiles 3004. The certain features or items of information may be selected randomly such that a random look-a-like candidate 3006 is sought which nevertheless has similar features or items of information as the look-a-like profiles 3004 and/or individuals. The certain features or items of information of the look-a-like profiles 3004 and/or individuals may additionally or alternately be combined by other manual or automatic procedures, such as by selecting a predetermined number of features from each of the look-a-like profiles 3004 and/or individuals based on a top-to-bottom ranking or by selecting the most prevalent or strongest features from each of the of the look-a-like profiles 3004 and/or individuals.

In even further embodiments of the present disclosure, the look-a-like profiles 3004 and/or characteristics of the individuals may be combined by establishing acceptable ranges of parameters in accordance with the items of information in the profiles. For example, each of the look-a-like profiles 3004 and/or individuals may include an education level, an experience level, a proficiency rating, a website ranking, or any combination thereof. Of course, these items are merely exemplary and the look-a-like profiles 3004 and/or individuals may additionally or alternatively include any additional or alternative item of information as described herein as relating to a profile, such as those items of information relating to the pillars described herein.

In the event that the look-a-like profiles 3004 and/or individuals are combined to create acceptable ranges, should one of the look-a-like profiles 3004 and/or individuals include a bachelor's degree for education level while another of the look-a-like profiles 3004 and/or individuals includes two years of graduate school for education level, the talent pool 208 may be searched for the look-a-like candidate 3006 who has between a bachelors degree and two years of graduate school as his or her education level. The same may be true for the other items of information in the look-a-like profiles 3004 and/or characteristics of the individuals. In this regard, if plural look-a-like profiles 3004 and/or individuals are provided which each have a same or similar ranking, level, score, or other evaluation for a particular, first item of information, such first item of information may be deemed important or essential and a narrow range of acceptability will be provided. In contrast, if the plural profiles and/or individuals have different rankings, levels, scores, or other evaluations for a particular, second item of information, such second item of information may be deemed unimportant or non-essential and a wide range of acceptability may be provided. In fact, should the plural look-a-like profiles 3004 and/or individuals have the different rankings, levels, scores, or other evaluations which exceed a predetermined threshold, such second item of information may be entirely disregarded. Of course, the above-examples for combining plural look-a-like profiles 3004 and/or characteristics of individuals are merely exemplary and additional or alternative means which are known and understood in the art may be employed. Also, the examples of the items of information in the look-a-like profiles 3004 and/or characteristics of the individuals are merely exemplary and not limiting or exhaustive. The look-a-like profiles 3004 and/or characteristics of the individuals may again comprise, or be limited by, any combination of the categories, pillars, or other data described herein. Such data may be searched from any of the areas or locations of the networks described herein, stored by any of the databases discussed herein, or provided by any additional source such as, for example, the hiring manager 202.

In any of the above-mentioned embodiments in which the plural look-a-like profiles 3004 and/or identifying information of plural individuals are received by the Sourcing Module 3010, the items of information in the look-a-like profiles 3004 and/or characteristics of the individuals may be weighted equally. Alternatively, the items of information and/or characteristics, may be assigned weights or ratios. For example, in the event three look-a-like profiles 3004 and/or individuals are provided, they may be assigned weights of 50%, 25%, and 25%. In such scenario, a resultant hybrid profile would have 50% of the items of information or characteristics of the first profile, or the acceptable ranges of the items of information or characteristics may be skewed toward the first profile. In further embodiments of the present disclosure, the look-a-like profiles 3004 and/or individuals may be weighted to the items of information of characteristics the profiles, themselves. For example, a resultant hybrid profile may be designated to have an education level of one of the look-a-like profiles 3004 and/or individual and a skill set of another of the look-a-like profiles 3004 and/or individual. The look-a-like profiles 3004 and/or individuals may be weighted or designated to correspond to any of the pillars described herein, or any of the various features or characteristics of any of the profiles set forth herein.

While the above-embodiments generally describe that a single look-a-like candidate 3006 is sourced, any number of look-a-like candidates 3006 may be sourced from any number of look-a-like profiles 3004 and/or individuals without departing from the scope of the present disclosure. For example, a predetermined number of look-a-like candidates 3006 may be sourced, a predetermined number of look-a-like candidates 3006 for which interviews may be established may be sourced, any number of look-a-like candidates 3006 which exceed a closeness or similarity ranking may be sourced, or the number of look-a-like candidates 3006 which are sourced may be variable depending upon criteria selected by the hiring manager 202. In this regard, the Interview Engagement Engine 3002 may automatically identify the look-a-like candidates 3006 for presentation to the hiring manager 202 or for further processing, or the hiring manager 202 may make selections from among potential look-a-like candidates 3006. That is, as described in previous embodiments, candidates 208 may be presented to the hiring manager 202, whereupon the hiring manager 202 may make selections from among the candidates 208 to identify the look-a-like candidates 3006. In this regard, any of the features relating to the preceding embodiments may be applied to the presently discussed embodiments. In any event, any number of look-a-like candidates 3006 may be sourced from any number of look-a-like profiles 3004 and/or individual without departing from the scope of the present disclosure.

Even further, the number of look-a-like candidates 3006 which is sourced, or the manner in which they are sourced, may be determined based on Artificial Intelligence 3014. Such Artificial Intelligence 3014 may be dependent or based on the acceptability of previous look-a-like candidates 3006 and/or the likelihood of such look-a-like candidates 3006 accepting an interview. For example, if the Artificial Intelligence 3014 identifies a certain number of look-a-like candidates 3006 from the talent pool 208 but determines that a percentage or number of the look-a-like candidates 3006 which is likely to accept an interview is below a predetermined threshold or number, the Artificial Intelligence 3014 may identify a greater number of look-a-like candidates 3006. In contrast, if the Artificial Intelligence 3014 determines that the percentage or number of look-a-like candidates 3006 which is likely to accept the interview is above the predetermined threshold or number, the Artificial Intelligence 3014 may identify a smaller number of look-a-like candidates 3006, such as the look-a-like candidates 3006 having a highest degree of similarity. Of course, the Artificial Intelligence 3014 may determine and source the look-a-like candidates 3006 by additional methods and means which are generally known and understood.

The Artificial Intelligence 3014 may additionally or alternatively identify the look-a-like candidates 3006 that are more likely to leave their current roles by analyzing a number of factors. The number of look-a-like candidates 3006 which is identified may additionally or alternatively be based on such information. The number of factors may include, but is not limited to, career history, career behavior patterns, digital footprint activity updates, digital footprint activity movements, title progression, promotions, location data, and data streams. The data streams may include, for example, Twitter, LinkedIn updates, industry data from blogs, and online publications including information such as company layoffs, revenue disclosures, acquisitions, funding and exit events, etc.

Upon identification of the at least one look-a-like candidate 3006, the Engaging Module 3012 initiates contact with or otherwise engages the look-a-like candidate 3006. The Engaging Module 3012 may utilize information of the look-a-like candidate 3006 which is sourced from the areas or locations of the at least one network 3008 as described herein to contact or engage the look-a-like candidate 3006, or may utilize information which is obtained by any of the other means described herein. The Engaging Module 3012 may contact or engage the look-a-like candidate 3006 for a discussion, in-person, electronic, or otherwise, with the hiring manager 202 or with any representative of the Interview Engagement Engine 3002. In this regard, the Artificial Intelligence 3014 may be used to contact the look-a-like candidate 3006 via the most appropriate means and via the most appropriate channels.

Once the look-a-like candidate 3006 has been contacted, the Artificial Intelligence 3014 may analyze response data to analyze and compare such response data to other look-a-like candidates 3006 to determine a probability at which the look-a-like candidate 3006 may be converted into an interview. The response data may include, but is not limited to, open rates of messages or other communication, open and read alerts, verbal and written responses and the timings thereof, and/or any sign of response across an application or communication medium. In this regard, the rates at which the look-a-like candidate 3006 opens, reads, and/or responds to any communication may be directly related or proportional to the probability at which the look-a-like candidate 3006 may be converted into an interview, and/or the times over which the look-a-like candidate 3006 opens, reads, and/or responds to any communication may be inversely related to the probability at which the look-a-like candidate 3006 may be converted into an interview The Artificial Intelligence 3014 may leverage technologies including, but not limited to, natural language processing (NLP) to analyze and compare the look-a-like candidate 3006 with the other look-a-like candidates 3006. The Artificial Intelligence 3014 may leverage such technologies across the same or different communication mediums and/or communication manners. Further, the Artificial Intelligence 3014 may determine the probability at which a single look-a-like candidate 3006 may be converted into an interview, or the Artificial Intelligence 3014 may determine the probability at which plural look-a-like candidates 3006 may be converted into one or more interviews. In any event, the Interview Engagement Engine 3002 may leverage the Artificial Intelligence 3014 to optimize an interview conversion rate, at which the look-a-like candidates 3006 are converted to interviews.

In certain embodiments of the present disclosure, the Engaging Module 3012 may initiate contact with the look-a-like candidate 3006 to request such discussion with the hiring manager 202. Upon acceptance of the request, the Interview Engagement Engine 3002 may notify the hiring manager 202 of the look-a-like candidate 3006, an arranged discussion, or both. As a result, the process for sourcing and initiating the discussion with the look-a-like candidate 3006 may be initiated via a single “click” or request of the hiring manager 202. That is, the hiring manager solely provides the look-a-like profile 3004, identifies the individual upon which the look-a-like profile 3004 is based, or provides the other identifying means whereupon the hiring manager 202 is next connected upon confirmation/acceptance of the request for the discussion or interview by the look-a-like candidate 3006. In such scenario, the hiring manager 202 need not necessarily provide any benefit or compensation to the Interview Engagement Engine 3002 unless the confirmation/acceptance of the request for the discussion or interview by the look-a-like candidate 3006 is presented to the hiring manager 202. As a result, the hiring manager 202 may request a certain number of confirmations/acceptances with benefit or compensation certainty.

Once the look-a-like candidate 3006 has been selected and either approved or declined by the hiring manager 202, recruitment team of the hiring manager 202, or the Interview Engagement Engine 3002, the Artificial Intelligence 3014, or other algorithm, may capture customer response behavior based on the look-a-like candidate 3006 and the look-a-like profile 3004. Any subsequent searches for look-a-like candidates 3006 based on look-a-like profiles 3004 may be modified based on the captured data. The data which is captured for combination of the look-a-like candidate 3006 and the look-a-like profile 3004 may be universally applied for all subsequent searches. Additionally or alternatively, the data may only be applied for subsequent searches by the hiring manager 202 and/or for subsequent searches for similar look-a-like profiles 3004. Accordingly, the subsequent searches will be progressively better, resulting in smart technology that is more focused on finding look-a-like candidates 3006 that the hiring manager 202, or hiring managers 202, tends to accept and less on finding look-a-like candidates 3006 that the hiring manager 202, or hiring managers 202, tends to decline. In other words, the subsequent searches will be result-driven.

The Artificial Intelligence 3014 may automatically determine the data which is used to optimize the subsequent searches, and/or the Artificial Intelligence 3014 may utilize data which is manually input by the hiring manager 202. For example, a user interface may include a thumb-up or thumb-down selection process for determining whether to move forward with each look-a-like candidate 3006, whereupon the Artificial Intelligence 3014 evaluates the acceptability of each look-a-like candidate 3006 based on the selection process. Of course, this example is merely exemplary and not limiting. The Artificial Intelligence 3014 may analyze many data points to determine which look-a-like candidates 3006 are more likely to be accepted and adjust subsequent searches based on that data. In any event the talent pool 206 from which the look-a-like candidates 3006 are selected and/or the sourced look-a-like candidates 3006 will be progressively better, based on likes and/or dislikes of hiring mangers 202 specifically, universally, and/or for specific profiles. Further, while an exemplary user interface was described above, it should be known and understood that any additional or alternative user interface may be used without departing from the scope of the present disclosure.

While the Artificial Intelligence 3014 was described generally above, further embodiments of any of the systems described herein may additionally and/or alternatively use artificial intelligence in accordance with any of the following.

The Artificial Intelligence 3014 may modify the criteria upon which the areas or locations of the network are searched. For example, with respect to the Look-A-Like System 3000 for sourcing and recruiting look-a-like candidates, the look-a-like profile 3004 may be continually refined and/or update based on the look-a-like candidates 3006. Specifically, if a predetermined number or a predetermined percentage of the look-a-like candidates 3006 have a certain characteristic in common with the look-a-like profile 3004, the Artificial Intelligence 3014 may increase a weighting of, emphasize, or further require such characteristic in the look-a-like profile 3004 in order to more consistently and continuously provide similarly matching candidates. In other words, the Artificial Intelligence 3014 may refine the look-a-like profile 3004 to provide more like or similar candidates. Alternatively, in contrast, if a predetermined number or a predetermined percentage of the look-a-like candidates 3006 have a certain characteristic in common with the look-a-like profile 3004, the Artificial Intelligence 3014 may decrease a weighting of, deemphasize, or not require such characteristic in the look-a-like profile 3004 in order to provide more diverse and dissimilar look-a-like candidates 3006.

The predetermined characteristic referred to in the preceding section and in the following sections may of course comprise multiple characteristics. Moreover, while the term characteristic is used, such term is not to be limiting. That is, the characteristic, or characteristics, may be any criterion or element of a profile based upon which a search may be conducted, as described herein. Furthermore, the characteristic may be a characteristic which exists in the look-a-like profile 3004, and/or it may be a characteristic which is not present in the look-a-like profile 3004. For example, if a certain characteristic is not present in the look-a-like profile 3004 or being searched for, but a predetermined number or a predetermined percentage of the look-a-like candidates 3006 have such characteristic, the characteristic may be added to the look-a-like profile 3004 as being apparently desirable. Also, if a certain characteristic is not present in the look-a-like profile 3004 or being searched for, but a predetermined number or a predetermined percentage of the look-a-like candidates 3006 have such characteristic, such characteristic may be added to the look-a-like profile 3004 as a negative or non-desirable characteristic in order to promote diversity. Even further, if the look-a-like profile 3004 is not complete or includes gaps or other missing criteria, the look-a-like candidates 3006 may be utilized to fill such gaps or missing criteria. The gap or missing criteria may be filled with a corresponding characteristic which is shared by a predetermined number or a predetermined percentage of the look-a-like candidates 3006, or the gap or missing criteria may be filled with a corresponding characteristic which is common amongst any two or certain number of the look-a-like candidates 3006.

Meanwhile, if a certain characteristic is present in the look-a-like profile 3004 and being searched for, and a predetermined number or a predetermined percentage of the look-a-like candidates 3006 have such characteristic, emphasis or more importance may be placed on the characteristic when searching based on the look-a-like profile 3004 in order to continue to provide similarly desirable candidates. Also, if a certain characteristic is present in the look-a-like profile 3004 and being searched for, and a predetermined number or a predetermined percentage of the look-a-like candidates 3006 have such characteristic, de-emphasis or less importance may be placed on the characteristic when searching based on the look-a-like profile 3004 in order to promote diversity.

Additionally or alternatively to the above, the Artificial Intelligence 3014 may also adjust the look-a-like profile 3004 based on a total number of the look-a-like candidates 3006. For example, if more than a predetermined number of look-a-like candidates 3006 are being returned as matches, the Artificial Intelligence 3014 may increase a requirement for matching one or any of the characteristics of the look-a-like profile 3004. That is, if the Artificial Intelligence 3014 determines that too many or more than a predetermined number of the look-a-like candidates 3006 are being found on account of a single characteristic, or characteristics, being too encompassing, the Artificial Intelligence 3014 may increase a requirement for matching such characteristic(s), such as by increasing a prevalence or numerical qualifier for satisfying the characteristic(s). In the embodiments in which the characteristic(s) relates to a range, the Artificial Intelligence 3014 may narrow or shrink such range of such characteristic(s). Additionally or alternatively, the Artificial Intelligence 3014 may add an additional characteristic in order to make matching more difficult. Accordingly, in these embodiments, the Artificial Intelligence 3014 may adjust the look-a-like profile 3004 in order to return a predetermined or desirable number of look-a-like candidates 3006.

In contrast, if less than a predetermined number of look-a-like candidates 3006 are being returned as matches, the Artificial Intelligence 3014 may decrease or relax a requirement for matching one or any of the characteristics of the look-a-like profile 3004. That is, if the Artificial Intelligence 3014 determines that too few or less than a predetermined number of the look-a-like candidates 3006 are being found on account of a single characteristic, or characteristics, being too strict or restrictive, the Artificial Intelligence 3014 may decrease a requirement for matching such characteristic(s), such as by decreasing a prevalence or numerical qualifier for satisfying the characteristic(s). In the embodiments in which the characteristic(s) relates to a range, the Artificial Intelligence 3014 may expand or broaden such range of such characteristic(s). Additionally or alternatively, the Artificial Intelligence 3014 may remove a characteristic in order to make matching easier. Accordingly, in these embodiments, the Artificial Intelligence 3014 may again adjust the look-a-like profile 3004 in order to return a predetermined or desirable number of look-a-like candidates 3006.

While the embodiments describe above relate to the Artificial Intelligence 3014 adjusting and modifying the characteristic of the look-a-like profile 3004, based upon which the areas or locations of the network are searched, in relation to found look-a-like candidates 3006, the Artificial Intelligence 3014 may additionally or alternatively modify the look-a-like profile 3004 based upon the desirable look-a-like candidates 3006 which are selected by the hiring manager 202 to be engaged for interviews. Even further, the look-a-like profile 3004, or any characteristic thereof, may further be adjusted, modified, or refined based upon any of the look-a-like candidates 3006 which are otherwise indicated to be acceptable or exemplary. For example, the hiring manager 202 could select or otherwise indicate exemplary look-a-like candidates 3006, whereupon the Artificial Intelligence 3014 could adjust, modify, or refine the look-a-like profile 3004 based upon the exemplary look-a-like candidates 3006 in accordance with any of the methods describe above. That is, instead of modifying the look-a-like profile 3004 based upon the found look-a-like candidates 3006 as described in the above-embodiments, the Artificial Intelligence 3014 could modify the look-a-like profile 3004 based upon the exemplary look-a-like candidates 3006 (or the look-a-like candidates 3006 which are to be engaged for interviews). Accordingly, the look-a-like profile 3004 may be even more precisely refined based upon input from the hiring manager 202.

Even further to the modification discussed in the preceding paragraph, the Artificial Intelligence 3014 may additionally or alternatively modify the look-a-like profile 3004 based upon the look-a-like candidates 3006 for which an interview is established. That is, instead of modifying the look-a-like profile 3004 based upon the found look-a-like candidates 3006 as described in the above-embodiments, the Artificial Intelligence 3014 could modify the look-a-like profile 3004 based upon those look-a-like candidates 3006 which are selected by the hiring manager 202 to be engaged and for which an interview is actually established by the Engaging Module 3012. According to these embodiments, the look-a-like profile 3004 may be even more precisely refined based upon the input from the hiring manager 202 and to also provide candidates which are more likely to accept an interview.

In even further embodiments in which the look-a-like profile 3004 is received, determined, or otherwise created from plural profiles, the Artificial Intelligence 3014 may modify the look-a-like profile 3004 by changing a weighting or relationship of the plural profiles. In this regard, the Artificial Intelligence 3014 may modify the look-a-like profile 3004 based upon any one or combination of the found look-a-like candidates 3006, the look-a-like candidates 3006 which are selected by the hiring manager 202 to be engaged for an interview, the look-a-like candidates 3006 which are otherwise indicated to be exemplary, or the look-a-like candidates 3006 with which an interview is established. The Artificial Intelligence 3014 may modify the look-a-like profile 3004 to favor or disfavor one profile based upon a closeness of the candidates to such profile. For example, each time a candidate is most closely related to one profile, the Artificial Intelligence 3014 may increase a weighting of such profile in the construction of the look-a-like profile 3004. Contrasting embodiments may also exist. That is, the Artificial Intelligence 3014 may decrease a weighting of each profile to which a candidate is not most closely related. Of course, these embodiments are merely exemplary and not limiting or exhaustive. That is, the Artificial Intelligence 3014 may change the weighting or relationship of the plural profiles based upon any additional or alternative methods described herein, as well as based upon further methods which are known and understood in the art.

The Artificial Intelligence 3014 may also, in addition or alternatively to the embodiments described above, modify the areas or locations of the network which are searched. Specifically, the Artificial Intelligence 3014 may modify the areas or locations of the network which are searched based on a number or quality of look-a-like candidates 3006 which are uncovered during the search. For example, the Artificial Intelligence 3014 may concentrate the search to certain areas or locations from which a predetermined number or a predetermine percentage of the look-a-like candidates 3006 are found, and/or the Artificial Intelligence 3014 may exclude certain areas or locations from the search when less than a predetermined number or a predetermined percentage of the look-a-like candidates 3006 are found. The Artificial Intelligence 3014 may also emphasize, or more strongly weight, certain areas or locations of the network over other areas or locations of the network. Accordingly, the Artificial Intelligence 3014 may also continually refine, update, and advance the areas or locations of the network which are searched.

In even further embodiments of the present application, while the Artificial Intelligence 3014 has generally been described as modifying the look-a-like profile 3004 based on the look-a-like candidates 3006, acceptable or exemplary look-a-like candidates 3006, and/or the look-a-like candidates 3006 for which an interview is established, the Look-A-Like System 3000 may provide the hiring manager 202 with a predetermined number of the look-a-like candidates 3006. The predetermined number of the look-a-like candidates 3006 may be selected randomly, based on a similarity to the look-a-like profile 3004, in order to have different characteristics generally or of the look-a-like profile 3004, in order to have varying characteristics selected from within the look-a-like profile 3004, based on a predetermined priority scheme, or any combination thereof. For example, in the event the predetermined number of the look-a-like candidates 3006 is selected in order to have varying characteristics selected from within the look-a-like profile 3004, the predetermined number of the look-a-like candidates 3006 may have different levels of education or work experience. As an additional example of the embodiment in which the predetermined number of the look-a-like candidates 3006 is selected in order to have different characteristics, the predetermined number of the look-a-like candidates 3006 may be selected to include diversity. The diversity may include race, color, religion, national origin, sexual orientation, gender identification, etc. Of course, the above-described embodiments and examples are merely exemplary and the predetermined number of the look-a-like candidates 3006 may be selected in accordance with any additional or alternative known and understood methods.

The hiring manager 202 may then select acceptable candidates or otherwise identify exemplary candidates from among the predetermined number of the look-a-like candidates 3006 as described herein, whereupon the Artificial Intelligence 3014 may update the look-a-like profile 3004 based on the selections or identifications in accordance with any of the embodiments of combinations thereof described herein. The Artificial Intelligence 3014 may additionally or alternatively update the criteria for selecting the predetermined number of the look-a-like candidates 3006 based on the selections or identifications. For example, the Artificial Intelligence 3014 may use positive and/or negative trends in the selections or identifications by the hiring manager 202. For example, if the hiring manager 202 continuously or frequently accepts and/or denies certain ones of the predetermined number of the look-a-like candidates 3006 that have and/or do not have a certain level of education, the Artificial Intelligence 3014 may update the look-a-like profile 3004 and/or the criteria for selecting the predetermined number of the look-a-like candidates 3006 (in a next or subsequent selection round) accordingly. The Artificial Intelligence 3014 may require that a threshold number of the selections or identifications by the hiring manager 202 satisfy the positive and/or negative trend in order to update the look-a-like profile 3004 and/or the criteria for selecting the predetermined number of the look-a-like candidates 3006 (in a next or subsequent selection round), and/or the Artificial Intelligence 3014 may require that a threshold ratio of the selections or identifications by the hiring manager 202 at least equals a predetermined ratio to satisfy the positive and/or negative trend in order to update the look-a-like profile 3004 and/or the criteria for selecting the predetermined number of the look-a-like candidates 3006 (in a next or subsequent selection round). For example, in the event that five candidates are provided to the hiring manager 202 with three having a certain level of education, the Artificial Intelligence 3014 may require that two of the three candidates be selected or identified by the hiring manager in order to satisfy the positive education trend, or the Artificial Intelligence 3014 may require that at least fifty percent of the three candidates with the certain level of education be selected or identified in order to satisfy the positive education trend. Of course, the above-described embodiments and examples are again merely exemplary and are not intended to be limiting or exhaustive. For example, the Artificial Intelligence 3014 may make comparisons between the candidates selected or identified by the hiring manager 202 to identify the positive and/or negative trends. The Artificial Intelligence 3014 may again require that such comparisons satisfy a threshold number or a threshold ratio as described above. Nevertheless, the Artificial Intelligence 3014 may even further identify the positive and/or negative trends in accordance with any additional or alternative known and understood methods.

In even further additional or alternative embodiments, the Artificial Intelligence 3014 may ignore certain trends and prohibit them from updating the look-a-like profile 3004 and/or the criteria for selecting the predetermined number of the look-a-like candidates 3006 (in a next or subsequent selection round). For example, in embodiments in which the predetermined number of the look-a-like candidates 3006 is selected to include diversity, the Artificial Intelligence 3014 may not update the look-a-like profile 3004 and/or the criteria for selecting the predetermined number of the look-a-like candidates 3006 (in a next or subsequent selection round) to exclude diversity. Moreover, the Artificial Intelligence 3014 may be configured to determine when diversity is being excluded from the candidates selected or identified by the hiring manager 202. The Artificial Intelligence 3014 may make such determination when a selection or identification percentage falls below a certain threshold or percentage. Furthermore, the Artificial Intelligence 3014 may issue an alert or notification to the hiring manager 202 and/or the Look-A-Like System 3000 when diversity is being excluded.

In the above-described embodiments in which the predetermined number of the look-a-like candidates 3006 is provided to the hiring manager 202, the Look-A-Like System 3000 may require that the hiring manager 202 approve, accept, select, identify as being exemplary, and/or make such other designation with respect to all of the predetermined number of the look-a-like candidates 3006, or to a predetermined number or percentage, before identifying candidates for a next or subsequent selection round in order to improve functioning of the Artificial Intelligence 3014. The Artificial Intelligence 3014 may additionally or alternatively increase or decrease the predetermined number of the look-a-like candidates 3006 which are provided to the hiring manager 202 in the next or subsequent rounds based on a number of the round and/or a percentage of candidates which are selected or identified as being exemplary in a prior round or rounds.

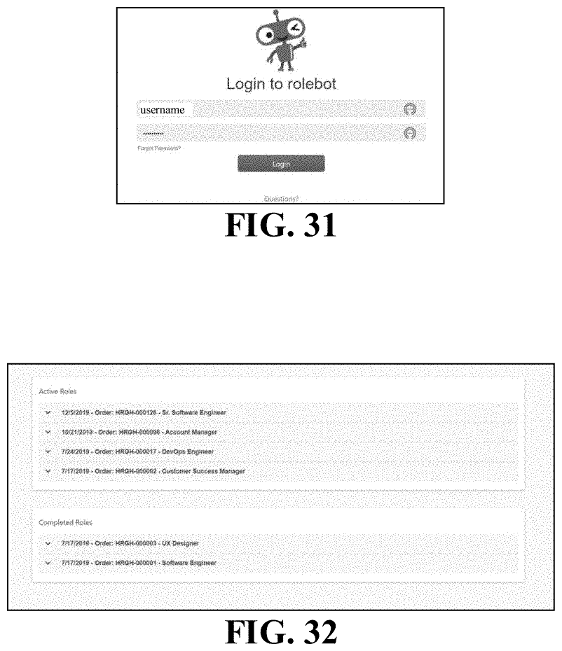

FIG. 31 to FIG. 55 show exemplary images and user interfaces of a system, such as the Look-A-Like System 3000, for souring and recruiting at least one look-a-like candidate 3006. These images are provided merely as examples and are not limiting or exhaustive. Each of the images may include any additional or alternative information and/or fields as known and understood in the art without departing from the scope of the present disclosure.

FIG. 31 shows an exemplary log-in page for the Look-A-Like System 3000. The log-in page may include input-fields for a username and password.

Upon completion of a log-in process, the hiring manager 202 may be directed to an order page as shown in FIG. 32. The order page may show active and completed searches. Each of the searches may be based on a look-a-like profile 3004, with the searches being defined as “roles”.

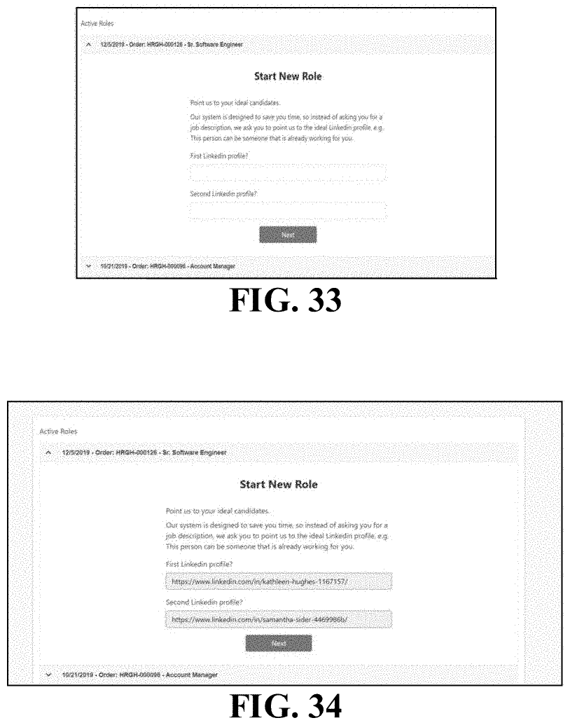

FIG. 33 and FIG. 34 show exemplary new search pages. In the embodiment of FIG. 33, the new search is to be based on two look-a-like profiles 3004, which each comprise a LinkedIn profile. The LinkedIn profile is identified for each of the look-a-like profiles 3004 by providing a corresponding URL. FIG. 34 shows the new search page with the URLs being entered.

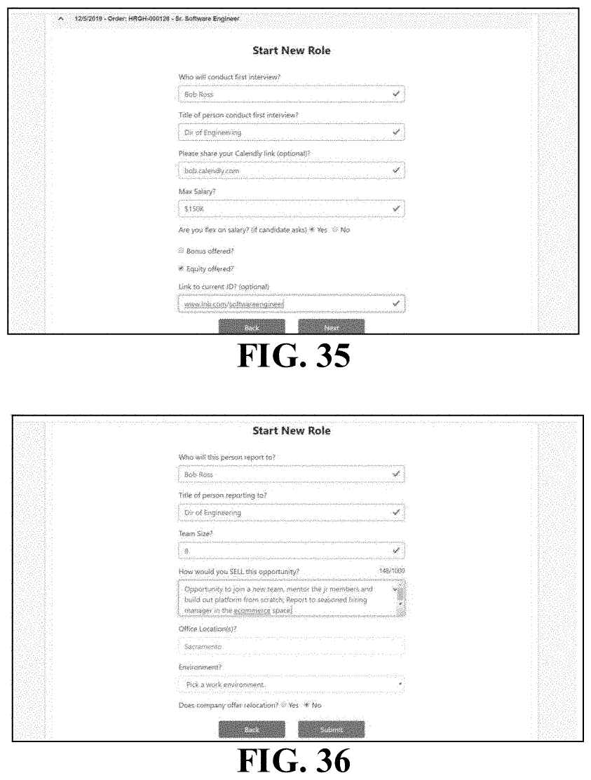

FIG. 35 and FIG. 36 show exemplary role information pages. In these pages, the hiring manager is able to provide information relating to the process by which the look-a-like candidate 3006 is to be hired and information relating to the role for which the look-a-like candidate 3006 is to be hired. Of course, the information shown in these pages is merely exemplary and may include any additional or alternative information.

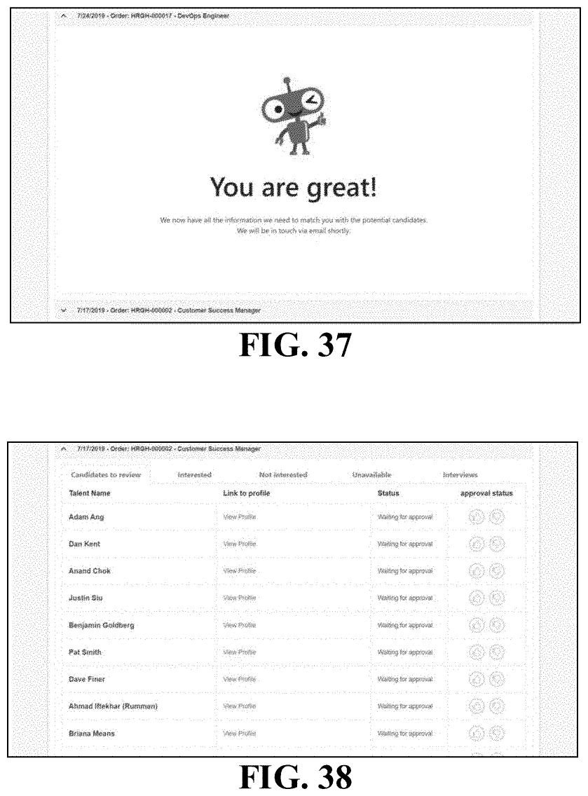

Upon completion of the new search page(s) as shown in FIG. 33 and FIG. 34 and the role information pages as shown in FIG. 35 and FIG. 36, a confirmation page as shown in FIG. 37 may be provided.

After providing the look-a-like profiles 3004, or identifying information thereof, and completing the search, the Interview Engagement Engine 3002 sources the look-a-like candidates 3006 via the talent pool 206 and/or the at least one network 3008 to determine the look-a-like candidates 3006. A results page which identifies the look-a-like candidates 3006 is shown in a results page as shown in FIG. 38. Each of the look-a-like candidates 3006 may be shown in association with his or her profile or a link thereto, a status, and an approval status.

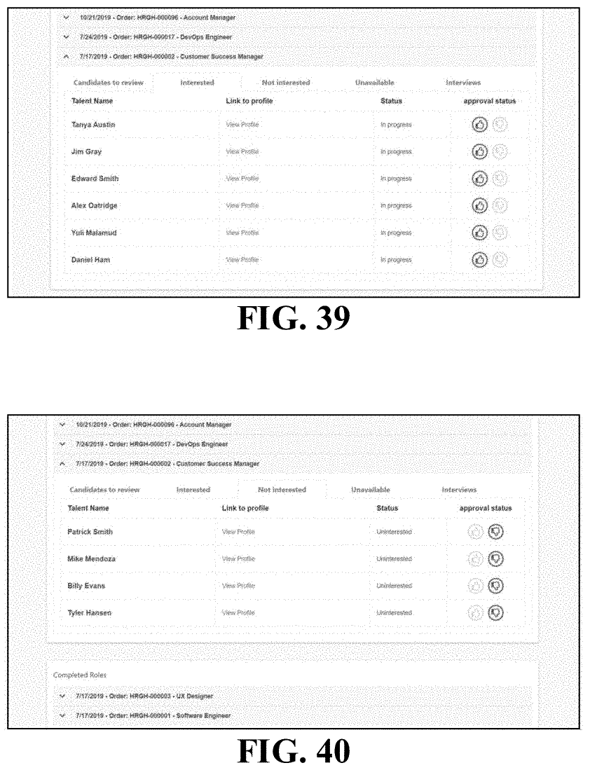

The hiring manager 202 and/or the Interview Engagement Engine 3002 may accept, via the approval status, any of the look-a-like candidates 3006 as generally shown in an accepted candidate page as shown in FIG. 39, or the hiring manager 202 and/or the Interview Engagement Engine 3002 may decline, via the approval status, any of the look-a-like candidates 3006 as generally shown in a declined candidate page as shown in FIG. 40. The accepted and declined ones of the look-a-like candidates 3006 may be shown in separate pages as shown in FIG. 39 and FIG. 40, or the accepted and declined ones of the look-a-like candidates 3006 may be shown in a same page.

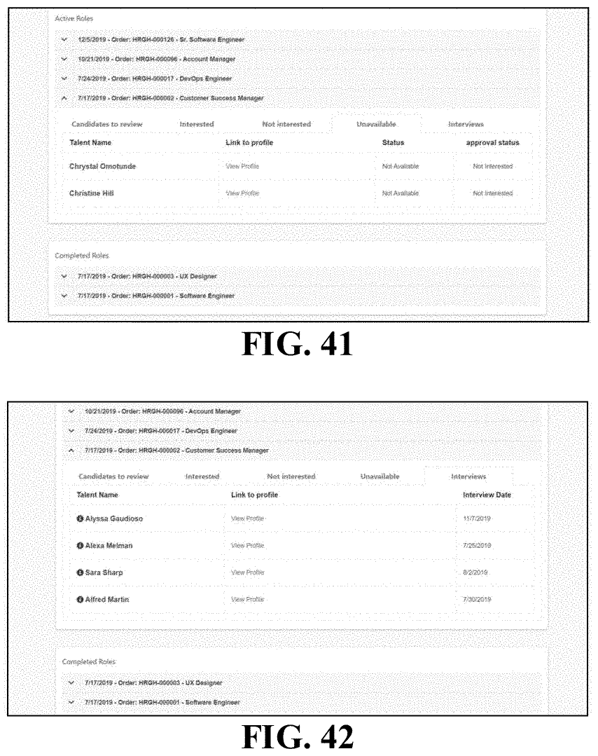

For the ones of the look-a-like candidates 3006 for which the approval status is accepted, the Interview Engagement Engine 3002 will engage such look-a-like candidates 3006 to determine interest in an interview. In this regard, the approval status of such approved look-a-like candidates 3006 may be modified to show any look-a-like candidates 3006 which are not interested in an interview in an interview declined page as shown in FIG. 41. In contrast, the approval status of such approved look-a-like candidates 3006 may be modified to show any look-a-like candidates 3006 which are interested in an interview in an interview accepted page as shown in FIG. 42. Again, the accepted look-a-like candidates 3006 which decline and accept the interviews may be shown in separate pages as shown in FIG. 41 and FIG. 42, or such look-a-like candidates 3006 may be shown in a same page.

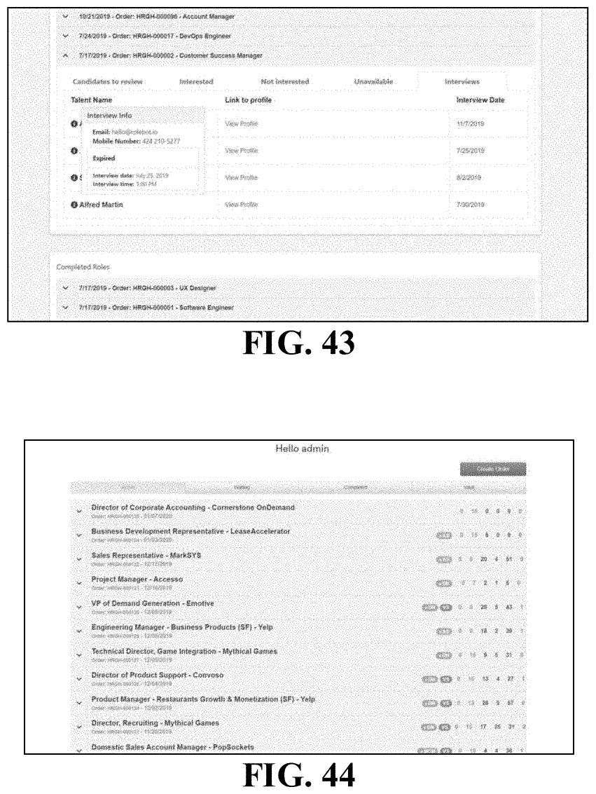

For the accepted look-a-like candidates 3006 which accept the invitation for the interview, a date of the interview may be shown in an interview schedule page as shown in FIG. 43.

In further embodiments of the Interview Engagement Engine 3002, an administrator of the Interview Engagement Engine 3002 view a collective role summary page as shown in FIG. 44. The collective role summary page may show all open and/or closed roles for any hiring managers 202, either individually per hiring manager 202 or collectively for all hiring managers 202. The collective role summary page my identify any combination of data described herein, including but not limited to, the number of look-a-like candidates 3006, accepted look-a-like candidates 3006, declined look-a-like candidates 3006, number of accepted look-a-like candidates 3006 for which interviews have been declined, number of accepted look-a-like candidates 3006 for which interviews have been scheduled and/or conducted, whether the role has been filled, etc.

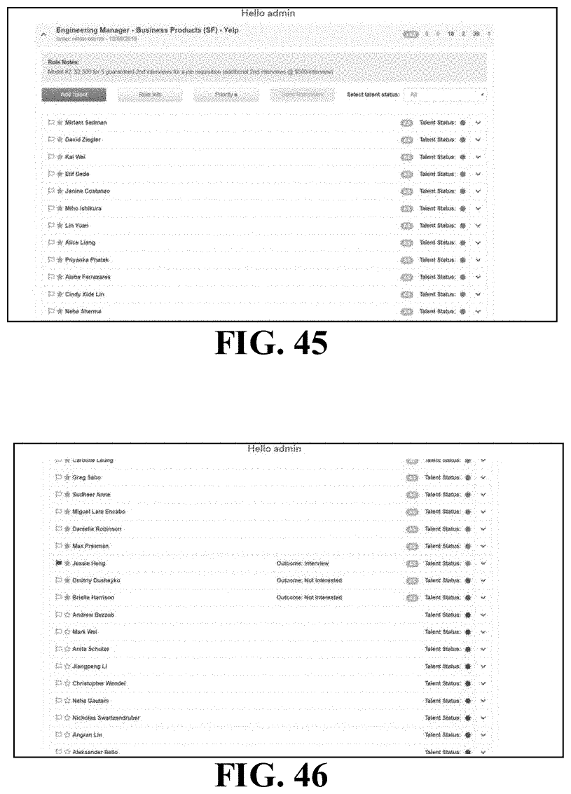

From the collective role summary page of FIG. 44, the administrator of the Interview Engagement Engine 3002 may individually view any of the individual roles in a role status page as shown in FIG. 45. Among any of the information described herein, the role status page may additionally show the requirements for a contract of the role between the Interview Engagement Engine 3002 and the hiring manager 202. For example, as shown in FIG. 45, the role status page may show a payment by the hiring manager 202 for a guaranteed number of interviews provided by the Interview Engagement Engine 3002. A further embodiment of the role status page without showing the contract is shown in FIG. 46.

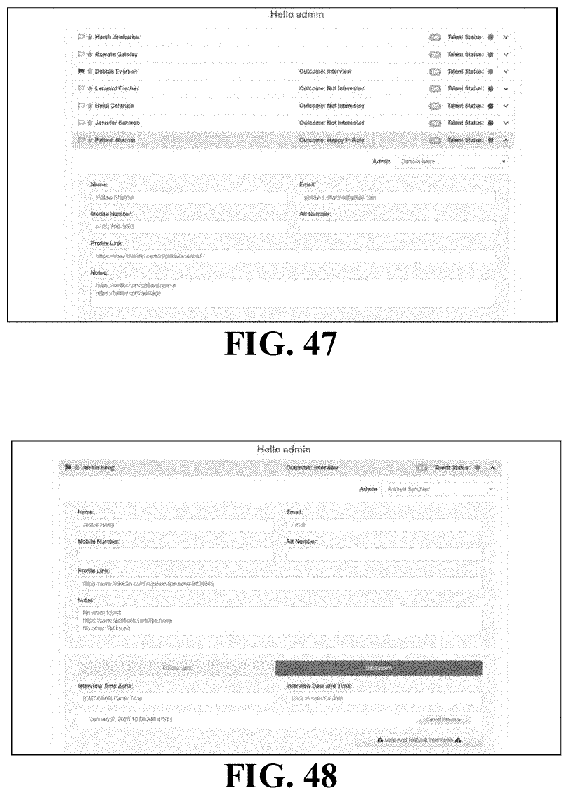

From the role status page, as shown in FIG. 47, the administrator may select one of the look-a-like candidates 3006 to view his or her contact information and/or any notes associated therewith. Selecting one of the look-a-like candidates 3006 may also display a separate look-a-like candidate page as shown in FIG. 48. The look-a-like candidate page may include any information about the candidate as generally described herein and/or known and understood in the art.

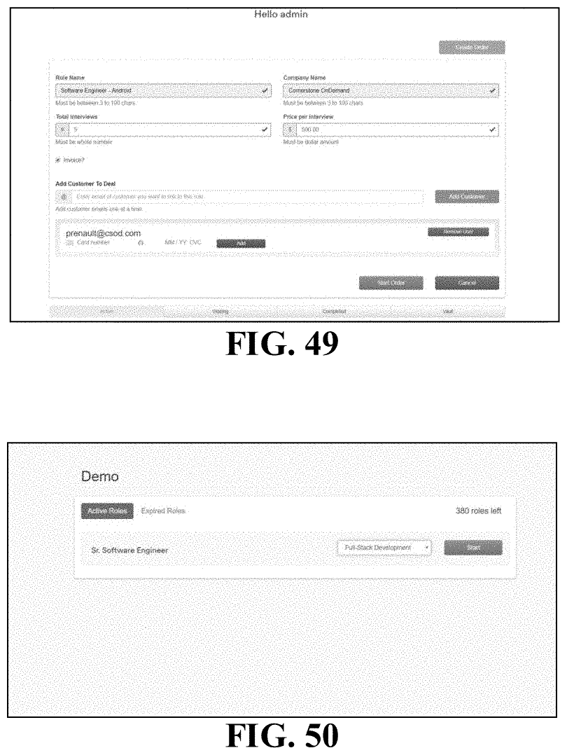

From the collective role summary page of FIG. 44, the administrator of the Interview Engagement Engine 3002 may also view the status and terms of an agreement for fulfilling a role, including the terms thereunder, in a role agreement page as shown in FIG. 49.

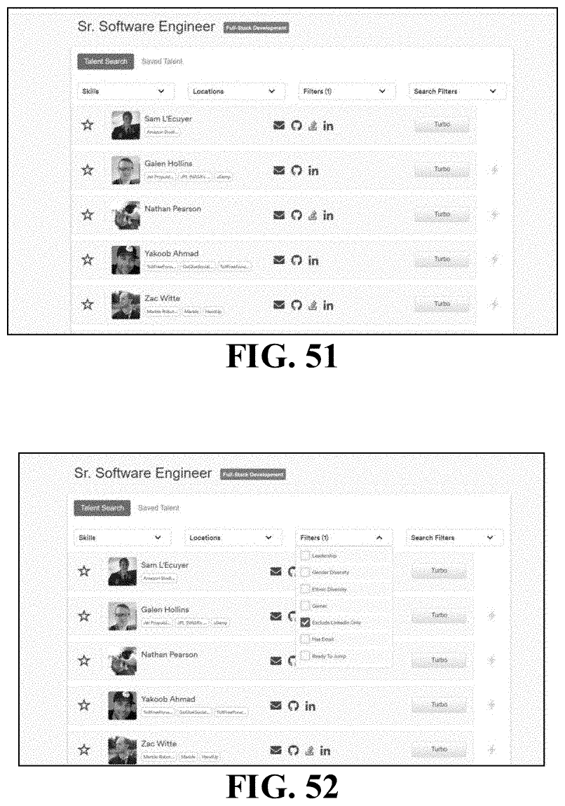

FIG. 50 shows a further feature of the Interview Engagement Engine 3002 in which the administrator may search for particular roles, based on type, via a demo page. Upon searching for a particular type of role, the sourced look-a-like candidates 3006 may be displayed in a candidates page as shown in FIG. 51. Again, the candidates page may include any combination of information described herein and/or any information generally known and understood in the art. The candidates page may be filtered based on skill, location, or any of the other criteria discussed herein as generally shown in the candidates page of FIG. 52.

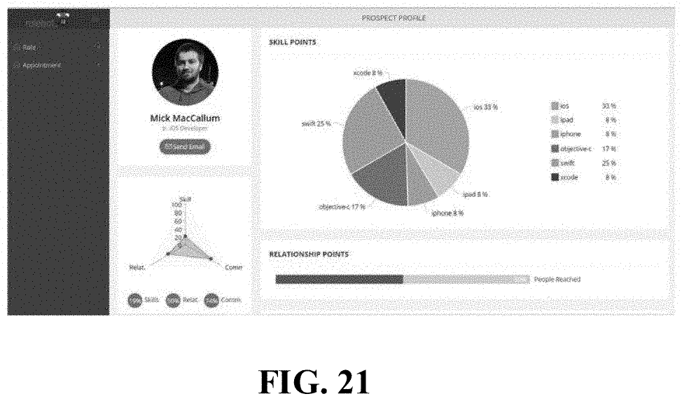

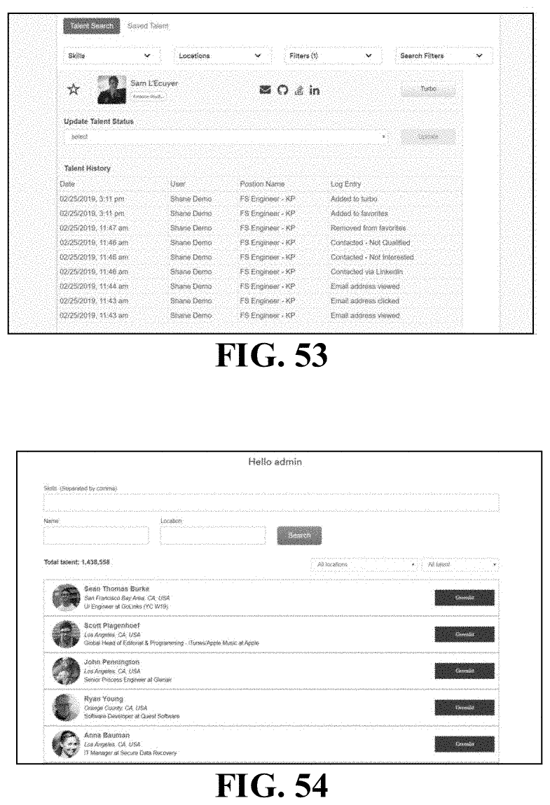

Each of the look-a-like candidates 3006 from the candidates page of FIG. 21 and FIG. 2 may be selected to show a specific candidate page as shown in FIG. 53. The specific candidate page may, in addition to providing any information specific to the candidate, show the specific candidate as she or he relates to the Look-A-Like System 3000. That is, the specific candidate may be shown as she or he relates to any roles, positions, or searches conducted by the Look-A-Like System 3000, including any activities undertaken with respect to each of the roles, positions, or searches.

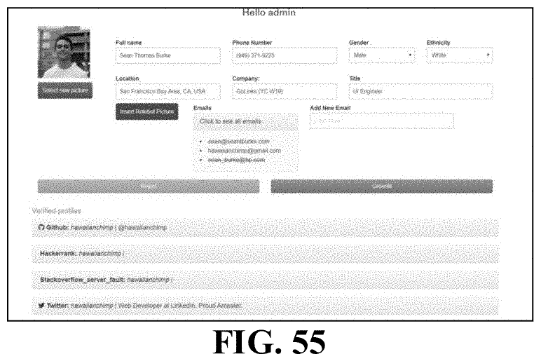

FIG. 54 shows a further feature of the Interview Engagement Engine 3002 in which the administrator may search, via a talent pool page, the entire talent pool 206 maintained by the Interview Engagement Engine 3002. The entire talent pool 206 may be searched in accordance with any of the criteria discussed herein which relates thereto. Each talent in the entire talent pool 206 may be individually selected to show information specific to the talent in a single talent page as shown in FIG. 55.

Again, as mentioned above, FIG. 31 to FIG. 55 show exemplary images and user interfaces of various embodiments of the Look-A-Like System 3000, for souring and recruiting at least one look-a-like candidate 3006. These images are merely examples and are not limiting or exhaustive. Each of the images may include any additional or alternative features as discussed herein without departing from the scope of the present disclosure.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system for sourcing and recruiting candidates into an interview process, the system comprising:
a processor; and
a memory including instructions that, when executed by the processor, cause the processor to perform operations, the operations including:
receiving, via an interface, identifying information, the identifying information identifying at least one individual;
determining, based on the identifying information, at least one search parameter, the search parameter relating to a characteristic of the individual;
creating, using the search parameter, a look-a-like profile;
first searching, via the interface, data from a search area of a network based on the look-a-like profile, the search area of the network defining a talent pool;
identifying at least one first look-a-like candidate from the talent pool based on the first searching, the first look-a-like candidate being different than the individual and having the characteristic in common with the individual;
modifying the look-a-like profile based on the first look-a-like candidate;
second searching, via the interface, the data from the search area of the network based on the modified look-a-like profile; and
identifying at least one second look-a-like candidate from the talent pool based on the second searching, the second look-a-like candidate being different than the individual and the first look-a-like candidate.

2. The system according to claim 1, wherein
in response to a predetermined percentage of the first look-a-like candidate having a second characteristic in common with the look-a-like profile, the look-a-like profile is modified in the modifying to remove the second characteristic.

3. The system according to claim 1, wherein
in response to a predetermined percentage of the first look-a-like candidate having a second characteristic that is not in the look-a-like profile, the look-a-like profile is modified in the modifying to include the second characteristic.

4. The system according to claim 1, wherein
in response to a predetermined percentage of the first look-a-like candidate having a second characteristic, the look-a-like profile is modified in the modifying to include the second characteristic as a negative characteristic.

5. The system according to claim 1, wherein
in response to a number of the first look-a-like candidate, which is identified in the first searching, exceeding a predetermined number, the look-a-like profile is modified in the modifying to increase a requirement for matching a second characteristic of the look-a-like profile.

6. The system according to claim 5, wherein
a range of the second characteristic of the look-a-like profile is narrowed in the modifying to increase the requirement for matching the second characteristic.

7. The system according to claim 1, wherein
in response to a number of the first look-a-like candidate, which is identified in the first searching, exceeding a predetermined number, the look-a-like profile is modified in the modifying to add an additional characteristic.

8. The system according to claim 1, wherein
in response to a number of the first look-a-like candidate, which is identified in the first searching, being less than a predetermined number, the look-a-like profile is modified in the modifying to decrease a requirement for matching a second characteristic of the look-a-like profile.

9. The system according to claim 8, wherein
a range of the second characteristic of the look-a-like profile is expanded in the modifying to increase the requirement for matching the second characteristic.

10. The system according to claim 1, wherein
in response to a number of the first look-a-like candidate, which is identified in the first searching, being less than a predetermined number, the look-a-like profile is modified in the modifying to delete a second characteristic.

11. The system according to claim 1, wherein
the operations further include:
determining a percentage of the first look-a-like candidate which is more likely than not to accept an interview, and
in response to the percentage being below a predetermined threshold, the look-a-like profile is modified in the modifying to increase a number of the second look-a-like candidate that is identified from the talent pool based on the second searching.

12. The system according to claim 11, wherein
the processor determines whether the first look-a-like candidate is more likely than not to accept the interview by contacting the first look-a-like candidate and analyzing response data from the first look-a-like candidate.

13. The system according to claim 1, wherein
the operations further include:
determining a percentage of the first look-a-like candidate which is more likely than not to accept an interview, and
in response to the percentage being above a predetermined threshold, the look-a-like profile is modified in the modifying to decrease a number of the second look-a-like candidate that is identified from the talent pool based on the second searching.

14. The system according to claim 13, wherein
the processor determines whether the first look-a-like candidate is more likely than not to accept the interview by contacting the first look-a-like candidate and analyzing response data from the first look-a-like candidate.

15. The system according to claim 1, wherein
the operations further include:
determining whether the first look-a-like candidate is more likely than not to leave a current role, and
the look-a-like profile is modified in the modifying to increase or decrease a number of the second look-a-like candidate that is identified from the talent pool based on the determining of whether the first look-a-like candidate is more likely than not to leave the current role.

16. The system according to claim 15, wherein
the processor determines whether the first look-a-like candidate is more likely than not to leave the current role based on factors, the factors including a career history, promotions, career behavior patterns, digital footprint activity updates, location data, and data streams.

17. The system according to claim 1, wherein
the operations further include:
receiving, via the interface, data from a hiring manger that indicates whether to contact the first look-a-like candidate, and
the look-a-like profile is modified in the modifying based on the data that is received from the hiring manager.

18. The system according to claim 17, wherein
the operations further include:
displaying the first look-a-like candidate on a display, and
the data that is received from the hiring manager via the interface includes a thumb-up or thumb-down selection process that indicates whether to contact the first look-a-like candidate.

19. A method for sourcing and recruiting candidates into an interview process, the method comprising:
receiving, via an interface, identifying information, the identifying information identifying at least one individual;
determining, by a processor and based on the identifying information, at least one search parameter, the search parameter relating to a characteristic of the individual;
creating, by the processor and using the search parameter, a look-a-like profile;
first searching, by the processor and via the interface, data from a search area of a network based on the look-a-like profile, the search area of the network defining a talent pool;
identifying, by the processor, at least one first look-a-like candidate from the talent pool based on the first searching, the first look-a-like candidate being different than the individual and having the characteristic in common with the individual;
modifying, by the processor, the look-a-like profile based on the first look-a-like candidate;
second searching, by the processor and via the interface, the data from the search area of the network based on the modified look-a-like profile; and
identifying, by the processor, at least one second look-a-like candidate from the talent pool based on the second searching, the second look-a-like candidate being different than the individual and the first look-a-like candidate.

20. A non-transitory computer-readable medium including a set of instructions for sourcing and recruiting candidates into an interview process that, when executed by a computer, causes the computer to perform operations, the operations comprising:
receiving identifying information, the identifying information identifying at least one individual;
determining, based on the identifying information, at least one search parameter, the search parameter relating to a characteristic of the individual;
creating, using the search parameter, a look-a-like profile;
first searching data from a search area of a network based on the look-a-like profile, the search area of the network defining a talent pool;
identifying at least one first look-a-like candidate from the talent pool based on the first searching, the first look-a-like candidate being different than the individual and having the characteristic in common with the individual;
modifying the look-a-like profile based on the first look-a-like candidate;
second searching the data from the search area of the network based on the modified look-a-like profile; and
identifying at least one second look-a-like candidate from the talent pool based on the second searching, the second look-a-like candidate being different than the individual and the first look-a-like candidate.
